(19) United States
(12) Patent Application Publication
(10) Pub. No.: US 2017/0033645 A1
(43) Pub. Date: Feb. 2, 2017

(54) Electromagnetic Generator

(71) Applicant: ZAG TECHNOLOGIES (IRELAND) LIMITED, Drogheda (IE)

(72) Inventor: Peter McCartney, Clogherhead (IE)

(21) Appl. No.: 15/302,829

(22) PCT Filed: Apr. 8, 2015
(86) PCT No.: PCT/EP2015/057634

§ 371 Date: Oct. 7, 2016

(30) Foreign Application Priority Data
Apr. 8, 2014 (GB) 1406329.1

(51) Int. Cl. H02K 7/18; H02K 35/02; H02K 1/34

(52) U.S. Cl. CPC H02K 7/1876; H02K 1/34; H02K 35/02

(57) ABSTRACT

The present invention relates to an electromagnetic generator for generating electricity comprising: an exciter having a first magnetic flux, an electrical conductor operable to generate a second magnetic flux when moved relative to the first magnetic flux, means for causing relative motion between the first magnetic flux and the conductor such that the second magnetic flux generated at the conductor opposes the motion of the first magnetic flux relative to the conductor to simultaneously generate an electromotive force (EMF) and a potential energy that is stored in the second magnetic flux, means for controlling the relative motion between the first magnetic flux and the conductor so that the potential energy stored in the conductor is released by allowing the second magnetic flux to collapse unimpeded by the first magnetic flux, and means for converting the released potential energy to an electromotive force (EMF) across the conductor. The invention further relates to a transformer and to an electric motor.

The present invention relates to a generator, in particular to an electromagnetic electric generator with continuous output, wherein the generator only derives external supply energy per part of the output electromotive force (emf) cycle. The invention further relates to a transformer and to an electric motor.

Where a conductor forming part of a closed circuit is in the vicinity of a magnetic environment and motion occurs between that environment and the conductor, an emf will be generated in that conductor. This is the basis of conventional generators. Energy external to this environment is required to facilitate this relative motion.

To efficiently generate an emf with a single motion or ‘stroke’ in this environment and ignoring losses to heat etc. the external supply energy should be equal but not exceed that required to cause a flux to peak in the conductor. At this peak, only a fraction of the generated energy is manifested in the conductor as emf, the remainder is stored in the conductor's established magnetic flux. The collapse of this previously generated flux will then generate a further emf that is equal or close and symmetrical to the previous emf generated where the flux was being established.

To oppose the natural and inevitable collapse of a previously established flux in the conductor requires ‘work’, effort, i.e. the flux must impart some of its energy to something external to this environment (normally the supply that caused the flux be established in the first place), depriving the conductor of this previously generated energy. This represents a significant loss.

The present invention seeks to alleviate the problems associated with the prior art.

According to a first aspect of the present invention there is provided an electromagnetic generator for generating electricity comprising:
an exciter comprising at least one magnet, the exciter having a first magnetic flux,
an electrical conductor operable to generate a second magnetic flux when moved relative to the first magnetic flux,
means for causing relative motion between the first magnetic flux and the conductor such that the second magnetic flux generated at the conductor opposes the motion of the first magnetic flux relative to the conductor to simultaneously generate an electromotive force (EMF) and a potential energy that is stored in the second magnetic flux,
means for controlling the relative motion between the first magnetic flux and the conductor so that the potential energy stored in the conductor is released by allowing the second magnetic flux to collapse unimpeded by the first magnetic flux, and
means for converting the released potential energy to an electromotive force (EMF) across the conductor.

In another embodiment, the electromagnetic generator further comprises means for moving the exciter and/or the conductor to cause the relative motion between the first magnetic flux and the conductor.

In another embodiment, the electromagnetic generator further comprises means for moving the first magnetic flux relative to the conductor to cause the relative motion between the first magnetic flux and the conductor.

In another embodiment, the means for moving the exciter and/or the conductor comprises mechanical moving means operable to move the exciter relative to the conductor.

In another embodiment, the exciter comprises an arrangement of a translator, magnets and ferrous material together providing a magnetic circuitry, whereby the relative motion between the first magnetic flux and the conductor is caused by relative movement of parts of the magnetic circuitry.

In another embodiment, in which a potential energy which is stored in the translator of the magnetic circuitry of the exciter and is released independently of a supply energy used to power the means for causing relative motion between the first magnetic flux and the conductor.

In another embodiment, the potential energy stored in the magnetic circuitry of the exciter is released non-instantaneously relative to the supply energy.

In another embodiment, the electromagnetic generator further comprises the conductor extends around a perimeter of the exciter, and a surface of the exciter is in contact with a surface of the conductor.

In another embodiment, there is no air gap between the contacting surface or contacting surfaces of the conductor and the exciter.

Preferably, the exciter and the conductor are immersed in a protective fluid.

Preferably, the protective fluid is epoxy resin.

Preferably, the magnet of the exciter is an electromagnet.

Alternatively, the magnet of the exciter is a permanent magnet.

According to a further aspect of the present invention there is provided a transformer comprising at least one primary conductor and at least one secondary conductor, the primary conductor having a first supply energy source and the secondary conductor for producing an EMF output,
the primary conductor comprising at least one electromagnet, the primary conductor having a first magnetic flux,
the secondary conductor operable to generate a second magnetic flux when moved relative to the first magnetic flux,
means for causing relative motion between the first magnetic flux and the secondary conductor such that the second magnetic flux produced at the secondary conductor opposes the motion of the first magnetic flux relative to the secondary conductor to simultaneously produce an electromotive force (EMF) across the or each secondary conductor and generate a potential energy that is stored in the second magnetic flux,
means for controlling the relative motion between the first magnetic flux and the secondary conductor so that the potential energy stored in the conductor is released by allowing the second magnetic flux to collapse unimpeded by the first magnetic flux, and
means for converting the released potential energy to an electromotive force (EMF) across the secondary conductor.

Preferably, the first supply energy source is an electrical energy supply having an alternating current (AC).

Preferably, the transformer is connected to a generator as described, in which the electrical energy supply is provided by the electromotive force (EMF) across the conductor of the generator.

According to a still further aspect of the present invention there is provided an electric motor for generating mechanical energy, the motor connected to an electrical energy supply source and comprising:
an armature,
a stator,
one of the armature and the stator comprising at least one magnet, and
the other of the armature and the stator forming an electrical conductor operable to produce a magnetic flux when connected to the electrical energy supply,
the electrical energy supply causing relative motion between the armature and the stator and to simultaneous produce a potential energy that is stored in the magnetic flux of the conductor,
means for controlling the electrical energy supply so that the potential energy stored in the magnetic flux of the conductor is released by allowing the magnetic flux to collapse unimpeded by the electrical energy supply, and
means for converting the released potential energy to mechanical energy causing further relative motion between the armature and the stator independently of the electrical energy supply.

According to a further aspect of the present invention there is provided a method of generating electricity comprising the steps of:
providing an exciter comprising at least one magnet, the exciter having a first magnetic flux,
providing an electrical conductor operable to generate a second magnetic flux when moved relative to the first magnetic flux,
operating means for causing relative motion between the first magnetic flux and the conductor such that the second magnetic flux generated at the conductor opposes the motion of the first magnetic flux relative to the conductor to simultaneously generate an electromotive force (EMF) and store a potential energy in the second magnetic flux,
controlling the relative motion between the first magnetic flux and the conductor so that the potential energy stored in the conductor is released by allowing the second magnetic flux to collapse unimpeded by the first magnetic flux, and
converting the released potential energy to an electromotive force (EMF) across the conductor.

Preferably, the method comprises a step of: moving the exciter and/or the conductor to cause the relative motion between the first magnetic flux and the conductor.

Preferably, the method comprises a step of: providing an arrangement of a translator, magnets and ferrous materials together having a magnetic circuitry, and moving parts of the magnetic circuitry to cause the relative motion between the first magnetic flux and the conductor.

Preferably, the method comprises a step of: providing a supply energy to power the means for causing relative motion between the first magnetic flux and the conductor and potential energy stored in the translator of the magnetic circuitry of the exciter is released independently of the supply energy.

Preferably, the method comprises a step of: releasing the potential energy stored in the magnetic circuitry of the exciter non-instantaneously relative to the supply energy.

Preferably, the method comprises a step of: immersing the exciter and the conductor in a protective fluid.

According to a further aspect of the present invention there is provided a method of producing an electromotive force (EMF) output comprising the steps of:
providing a transformer comprising: a primary conductor having at least one electromagnet, the primary conductor having a first magnetic flux, and a secondary conductor operable to generate a second magnetic flux when moved relative to the first magnetic flux;
providing a first supply energy source to the primary conductor;
operating means for causing relative motion between the first magnetic flux and the secondary conductor such that the second magnetic flux produced at the secondary conductor opposes the motion of the first magnetic flux relative to the secondary conductor to simultaneously produce an electromotive force (EMF) across the or each secondary conductor and generate a potential energy that is stored in the second magnetic flux,
controlling the relative motion between the first magnetic flux and the secondary conductor so that the potential energy stored in the conductor is released by allowing the second magnetic flux to collapse unimpeded by the first magnetic flux, and
converting the released potential energy to an electromotive force (EMF) across the secondary conductor.

Preferably, the method comprises a step of: providing the first supply energy source as an electrical energy supply having an alternating current (AC).

Preferably, the method comprises a step of: comprising a step of: connecting the transformer to a generator configured according to any one of claims 1 to 12, such that the electrical energy supply is provided by the electromotive force (EMF) across the conductor of the generator.

According to a further aspect of the present invention there is provided a method of generating mechanical energy comprising the steps of:
providing an electric motor comprising: an armature and a stator,
connected the electric motor with an electrical energy supply source
providing one of the armature and the stator with at least one magnet,
configuring the other of the armature and the stator as an electrical conductor operable to produce a magnetic flux when connected to the electrical energy supply,
controlling the electrical energy supply to cause relative motion between the armature and the stator and to simultaneous produce a potential energy that is stored in the magnetic flux,
further controlling the electrical energy supply so that the potential energy stored in the magnetic flux is released by allowing the magnetic flux to collapse unimpeded by the electrical energy supply, and
converting the released potential energy to mechanical energy causing further relative motion between the armature and the stator independently of the electrical energy supply.

Thus, according to a first aspect of the invention, there is provided an electromagnetic generator comprising an exciter and a coil, wherein said exciter and coil are movable relative to each other such that movement of the exciter towards the coil by an external energy supply causes a magnetic flux to be generated in the coil that opposes the motion of the exciter.

Preferably, relative movement of the exciter externally past the coil or through a centre of the coil collapses the magnetic flux in the coil. In this embodiment, no mechanical energy from the external energy supply is required to hamper this collapse. In this embodiment, the rate of motion of the exciter externally past the coil or through a centre of the coil should be the same as the rate of motion that established the flux (the movement of the exciter towards the coil).

The exciter arrangement is such that its continued motion or a change in its motion, e.g. stopping, cannot oppose the collapse of the previously established flux in the output coil/winding.

The exciter is constructed from an arrangement of magnets ‘like’ pole to ‘like’ pole, providing a single primary and concentrated flux that lies at right angles and diametrically to the exciter's motion and is no greater in width that the exciter's length with respect to its motion and two ‘like’ smaller fluxes to each end of the exciter that are opposite in polarity the primary flux.

Preferably, the exciter comprises a pair of magnets, wherein ‘like’ poles of each magnet face towards each other. Additionally, a ferrous pole shoe can be installed between the magnets for the purpose of manipulating and focusing where the primary and/or secondary fluxes lie in the system.

The relative motion generators described herein do not require a pole shoe for them to operate. The presence of a pole shoe on a relative motion generator helps to focus the magnetic flux in a preferred way only.

The non relative motion generators described herein do require the presence of a pole shoe. The pole shoe acts as part of the magnetic circuitry.

Where a pole shoe is deemed necessary the dimensions will be determined with respect to the generator's design and construction. The shoe size and shape on the non relative motion generator will be largely dictated by the flux and the magnets shape, e.g. a rectangular magnet would most likely have a rectangular shoe but not always necessarily. The shoe should be as close as possible to, preferably in contact with, the pole magnetic surfaces. In a preferred embodiment, the surfaces of the magnets and pole shoes are even. This provides a flat surface to wind to, or fix the winding to. Alternatively, the pole shoe is proud of the magnetic surface.

Preferably, the magnets are ring magnets, however, the magnets may each take any shape. The exciter may comprise electromagnets or a combination or magnet and electromagnet.

In an alternative embodiment, the exciter is a single coil, where one half is wound in the opposite direction of the first half. The exciter is constructed so as it motion (or lack off) can preferably never, or mostly not, oppose the collapse of a previously established flux caused by this same and continued motion, or lack thereof.

The relative motion exciter has two like poles at both ends, these fluxes lie in the form of ‘natural’ flux, though can be compressed where a pole shoe is used. These are referred to herein as the exciter's secondary fluxes. There is a single primary forced flux and this represents the largest percentage of the available flux from the magnets, the ideal is to concentrate as much of the available flux into this area. This forced flux lies at right angles to the direction of motion or the ends natural fluxes. With ring magnets it is diametric to exciter (much in the same way the coil is when the exciter sits in its bore). This flux is highly concentrated into this narrow ‘window’. It peaks at right angles to the exciter's centre and does not lie outside the length of the exciter. The flux is so highly concentrated that the exciter is operated within the bore of the coil. Preferably, some small part of the exciter should always lie within the coil's bore.

Advantageously, by setting off additional winding or groups of windings relative to the moving flux, dual and multi phase outputs can be achieved.

The non relative motion exciter is much like a Halbach arrangement, other than the end poles each pole width has a single (diametric with ring magnets) flux occupying an area similar the coils. Each pole is opposite in polarity that on either side.

In the embodiment having ring magnets, the shoe is preferably annular, particularly preferably wherein the internal diameter of the shoe is equal to the internal diameter of the ring magnets.

Preferably, the exciter further comprises a mount, wherein the magnets and optionally a ferrous shoe are mounted thereon.

A mount on a non-relative motion generator is preferably ferrous as this is part of the magnetic circuitry. In this embodiment, the ferrous mount should be as thin as possible as it is providing a level of magnetic circuitry.

The advantage of this arrangement is that the generator only derives external supply energy per part of the generated emf cycle. External supply energy is required to overcome this force and allow the exciter's motion to continue. Meanwhile an emf is generated in the coil. In other words, the generator only requires external supply energy to facilitate the first part of its cycle (where the flux is established) per generated emf cycle.

Optionally, the exciter comprises one or more like poles.

In the embodiment having ring magnets, the mount is preferably cylindrical with an external diameter equal to the internal diameter of the ring magnets.

The external supply energy is selected from among electrical and mechanical energy.

Preferably, said supply energy is half of the generated emf cycle.

The coil is a conductor. Preferably, the coil is made of copper. It is worth noting that the coil does not have to be annular.

In a preferred embodiment, the exciter comprises a magnet array comprising a plurality of ring magnets and annular ferrous shoes, wherein said ring magnets and ferrous shoes are arranged such that each ferrous shoe is between two magnets, electromagnets or combination of magnet and electromagnet.

In a preferred embodiment, said generator further comprises a rotor or translator. These components are used to store energy.

In a further aspect, the invention provides a translator for the generator described herein, the translator comprising a mount and a plurality of shoes mounted thereon.

The translator is preferably made from steel or another suitably ferrous material and can possibly be formed from one piece of material on a lathe or similar.

When the translator lies across the pole shoes, the flux collapses due to the completed magnetic circuitry.

Preferably, the shoe makes contact with the translator.

In use, where the larger outer diameter of the translator lies across two pole shoes, the magnetic flux associated with these shoes is collapsed or compressed, however the magnetic polarity never changes. In other words, where the translator lies across two pole shoes, magnetic circuitry is provided which redirects the tendency of the flux, via the pole shoes, through the translator.

Where the inner diameter of the translator lies across two shoes, in the absence of the magnetic circuitry across the pole shoes the flux associated with these shoes is ‘expanded’ outward through the coil. Where motion of the translator causes the flux across two neighbouring poles shoes to collapse, the poles immediately to each side of this will expand and so on throughout the length of the generator. Again, there is no energy required from the supply per part cycle (e.g. per approximately half cycle).

The stroke length is defined only by the inexpensive translator not the exciter array or stator (coil).

The generators described herein fall into two primary categories:
Generators (also applicable to electrical motors) having relative motion between the exciter (i.e. magnets or magnet array) and the output/field windings (e.g. a coil).

In such a generator, be it rotary or linear, the relationship between the input energy (i.e. external supply energy) and the output energy (i.e. generated emf) is semi-instantaneous.

In a linear generator, the exciter and stator (coil) are preferably equal, or close, in length.

By semi-instantaneous generator is meant that the collapse of a previously established flux in the output windings (field or secondary) is not opposed by the external supply energy. Therefore no work is derived from the supply during this collapse but an emf is still available in the winding. That is, the collapse of a previously established flux in the output windings does not oppose the original flux that caused this flux in the output windings to be established in the first place. The power available from the output winding during this ‘collapse’ part of the cycle will be close to symmetrical to that found in the previous part of the cycle where the flux was established in the output winding in the first place and where energy was drawn from the supply.

The semi-instantaneous generator can be reversed and used as a rotary or linear electric motor.

For example, where relative motion occurs between a magnetic environment and a closed circuit conductor, for a single stroke in this environment and for this duration to a point where a flux is established and peaks in the conductor an emf will be manifested in the conductor. Where the supply energy is then removed as the flux in the conductor peaks, the remainder of this generated energy will then be manifested as emf in the conductor independent of the supply energy for this duration.

In an alternative arrangement, the exciter cannot move through (or past) the coil and the coil is connected to an electrical supply causing a magnetic flux to be established in this. In this arrangement, the establishing flux will cause relative motion between the coil and the exciter. Where the flux then peaks in the winding the supply is disconnected and close to simultaneously the winding is caused to be short circuited. The collapse of the previously generated flux in the winding will cause further motion of the exciter independent of the supply energy for the duration of this collapse.

The exciter preferably comprises a short-circuited winding/coil and preferably further comprises a ferrous core.
Generators without relative motion between the exciter and the output/field windings.

Such a generator, be it rotary or linear, is specifically designed for conditions where large counter magnetic forces are required and for low velocity operation. It is possible to protect the primary components (magnets/exciter and windings/stator) of these generators in a way which is not possible with conventional generators making these ideal for operation in the harshest of conditions. For example, these components can be immersed in epoxy resin, or similar, without the need for seals etc. to facilitate moving parts. In such generators the length of the exciter and the length of the conductor (stator) are preferably equal or very close. The windings can also be wound directly to the exciter's magnetic surfaces negating the need for an air gap and associated losses.

In an alternative embodiment, the rotor or translator of the generators without relative motion between the exciter and the output/field windings can be moved at low velocity in any duration within practical reason such as a mm per week or slower. Energy stored in the generator's flux and magnetic circuitry is then ‘fired’ generating an emf with a high velocity motion of the rotor/translator. This firing can be further facilitated where the rotor/translator part in contact with the pole shoes is allowed to move independently of the drive medium when it reaches the point of ‘firing’. The means of allowing the exciter to fire or move freely of whatever connects it to the force that is driving it, allowing it to jump freely when it reaches that point where its motion is no longer opposed by the flux and the flux ‘sucks’ it in (just past mid pole) is preferably a simple ratchet or free-wheel system. This embodiment is especially useful where vast slow moving forces are available to drive the generator such as tidal displacement of vast tonnages of water. Therefore the relationship between the input energy and the output energy can be semi-instantaneous or non-instantaneous.

By non instantaneous generator is meant a generator, wherein the mechanical energy input to this system can typically be input over any duration at any time prior to a flux being established, or the collapse of this flux, in the output windings.

In a preferred embodiment, said generator further comprises a spring. The spring is used to store energy.

In the non instantaneous generator the established and collapsing flux in the winding are both independent of the external supply energy.

In a preferred embodiment, relative motion between the coil and the exciter, e.g. magnet array, occurs in a reciprocating stroke like manner.

According to a further aspect of the invention, there is provided a transformer comprising an exciter and a coil, wherein the exciter comprises at least one electromagnet.

Preferably, the exciter comprises at least two magnets and optionally at least one ferrous shoe, wherein ‘like’ poles of each magnet face each other or, if present, the shoe, and wherein the load does not oppose the supply per part of generated emf cycle.

Preferably, the coil is made of copper.

The generator described herein stores mechanical energy in the exciter's flux and associated magnetic circuitry. There is no lower limit (other than practicality, i.e. in the range of less than a mm per year) to rate or velocity this storage can occur. Subsequently, this stored energy can be ‘fired’ to generate electrical energy. This storage/firing affect can be further enhanced with a mechanical spring or similar.

Preferably, the generator that stores mechanical energy in the exciter's flux and associated magnetic circuitry is an inverted hydro generator which may be driven by a weight such as a body of water.

The inverted Hydro Generator moves just under the distance of half a pole width in one direction. Energy stored in the magnetic flux and magnetic circuitry is then fired in the opposite direction or follows through in the same direction where the initial movement would be slightly greater than half a pole width. This storage of energy and ‘firing’ can be further added to with a spring or similar. This restriction of motion can be imposed by the mechanical supply. This cycle should occur in rapid succession.

The Inverted Hydro generator is fired when the weight is removed or displaced. This design is mostly intended for the conversion of large volumes slow moving tidal water or similar bodies to electrical energy. The energy stored does not so much relate to the horizontal flow of the water, though this is required, but an energy at right angles to this, mass*gravity. There are various means to achieve this and only the nature of the electrical generator required is described herein.

The motion of the translator causes the original flux to recede or collapse, slowly, through the winding.

The primary aspects of the technology of the generator described herein are:
a) An electromagnetic electric generator that only derives external supply energy per part, normally half, of the generated emf cycle. Despite this the generated output is continuous. To enable this, the necessary and tendency of a previously established flux to collapse through in the generator's output coil does not oppose the nature or motion of the flux in the exciter/primary windings (original flux) in this part of the cycle.
b) Energy can be stored by motion of a rotor or translator at any velocity over any duration in a spring like manner between the exciter flux and associated magnetic circuitry. This energy can then be ‘fired’ or released at a high velocity. This storage of energy can be further enhanced with a spring or the like. Practically this ‘firing’ should occur in rapid succession.
c) The inverted hydro generator according to the invention is a generator that has been specifically designed to harness energy from the displacement and vast tonnages of the tidal waters that are dumped then extracted from our coasts and rivers etc every second of every day, though not limited to this use. Per second for the smallest of areas this can represent thousands of tonnes of ocean water available per second multiplied by gravity to drive these generators. This energy is relentless and available every second of every day and is vast. Like any other hydro electric system, the inverted hydro generator according to the invention requires a reservoir adjacent to or parallel to an ocean or a river. There is no upper body of water required in the way is necessary with conventional hydro systems. Instead, the upper body of water to be used alternates from the reservoir to the ocean body. The output of the inverted hydro generator according to the invention is dictated by the reservoir size and the equipment available to convert this energy.

All bar one of the generators herein described refer to linear models for simplicity. However, these principles apply equally to rotation or combined rotary/linear generators. Thus, the generator can be driven in a linear manner, in a rotational, manner, in a linear/rotational combination.

The rotary generator demonstrates an alternative way of generating a flux in the conductor. Optionally, in rotary versions a second coil can be laid onto the other coil with the exciter in the middle of both coils. The coils can then be connected in parallel or in series.

For a generator where relative motion occurs between the generator's coil and exciter the ferrous shoe is not a compulsory requirement whereas it is with generators that have no relative motion between the mass of the exciter and the coil.

In a preferred embodiment, the generator is a multi-poled linear generator having at least two magnets and at least three ferrous shoes mounted to the mount, wherein no relative motion is required between the exciter's mass and the coil.

Unlike conventional linear generators, none of the primary components (magnets and coil(s)) are ever redundant in the linear generators described herein. Additionally due the nature of this construction it is possible to 100% protect the primary components (in epoxy resin etc.) making them impervious to moisture ingress etc. in a manner that is not possible with the conventional generator. There are also advantages in relation to flux linkage and no air gap is required between the exciter magnetic surfaces and the coil(s). Air gaps are usually significant in linear generators and represent a large redundancy in available flux.

The generator described herein derives work from the supply per part cycle where there is no relative motion between the exciter's flux and coil's flux per part, preferably half, of the generated emf output cycle.

Preferably, the generator has no relative motion between the exciter's mass (windings/magnets) and output's mass (stator/windings/coil). An air gap is not required between the exciter's magnetic surfaces and output windings.

The technology described herein is completely compliant with Faraday's Law and is applied as follows:
1) The conductor moves relative to the magnetic environment and where a magnetic flux or field is being established that is associated with the conductor, this rising flux will oppose the magnetic environment (the original flux) and in turn this motion will be opposed. External energy is required to facilitate this relative motion between these fluxes, be it mechanical or electrical.
2) For the duration of this motion and where this continued motion causes a magnetic flux to be established to a peak and associated with the conductor, relative motion ceases between the original flux and that associated with the conductor (this does not always imply that mass associated with both these fluxes are not moving relative to each other) and the conductor's flux then begin to collapse. To the point where this flux reaches its maximum peak, for this motion, an emf will have manifested in the conductor and further generated energy will be manifested in the conductor but as energy stored in the established magnetic flux. From the peak of this flux and for the duration of its collapse this will not be opposed by the original flux, the magnetic environment. Therefore no external energy is required in this part of the cycle as there is no relative motion between the fluxes in this part of the cycle yet an emf will be measured and is available in the conductor for the duration of this collapse. This emf is usually close to equal and symmetrical to the emf measured in the first part of the cycle (where the flux associated with the conductor is being established).

This emf measured and available in the second part of this cycle is derived from energy stored in the first part of the cycle and is a result of the external energy that caused the first part of the cycle, where the flux is established in the conductor. Simply put this emf is available due to the natural collapse of a previously established magnetic flux/field associated with the conductor.

It is important to note that for the duration of this collapse of flux in the conductor, while there is no relative motion between the original flux and the conductor's flux there may be relative motion between the masses associated with each of these fluxes, exciter and output winding.

The flux generated in the output windings of the designs described herein, including generators, transformer and inductors only oppose the motion of the original magnetic flux while the flux in these output windings is being established. To achieve this with these machines, irrespective of relative motion associated with the mass of the conductor and the mass associated with the magnetic environment (e.g. the magnet), once the magnetic flux established in the conductor peaks there can be no relative motion between the magnetic fluxes in this environment until this previously established flux in the conductor completely collapses.

Where the exciter approaches the conductor (relatively) then passes through or past it (while moving in the same direction), the polarity of the original magnetic flux relative to the conductor must be maintained with respect to the conductor throughout the generated emf cycle. Alternatively, the original magnetic flux must be manipulated such that motion or lack of motion between the mass associated with the exciter and the mass associated with the conductor do not cause relative motion in the conductor/exciter's magnetic environment after a flux has been established in the conductor and until the flux in the conductor is fully collapsed.

The natural decay or collapse of the flux in the output windings of the devices described here is unopposed by the continued motion, or lack of motion, of the original flux that caused this generated flux associated with the conductor/winding in the first place and therefore independent of the supply be it, electrical or mechanical, in this part of the cycle.

The invention will be more clearly understood from the following description of some embodiments thereof, given by way of example only, with reference to the accompanying drawings.

In the drawings:

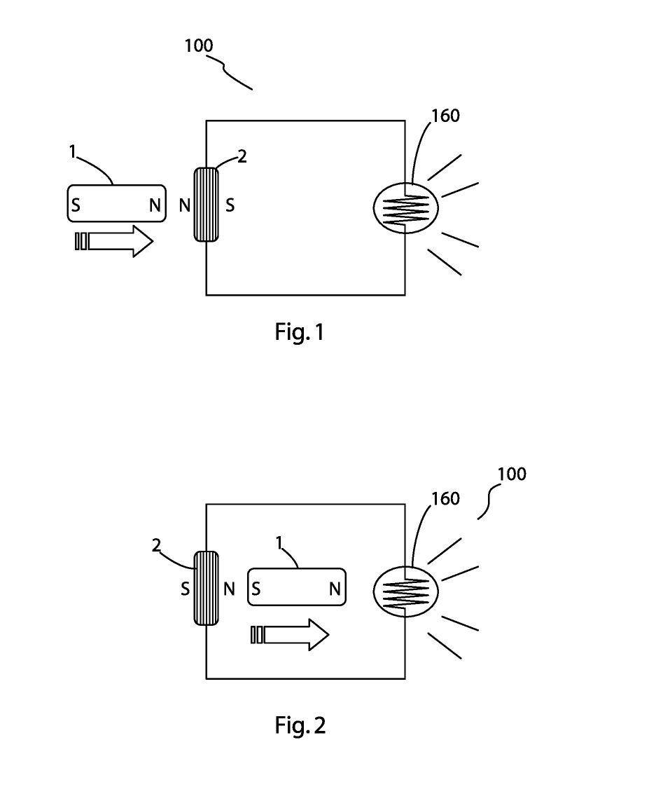

FIG. 1 shows a simple conventional generator;

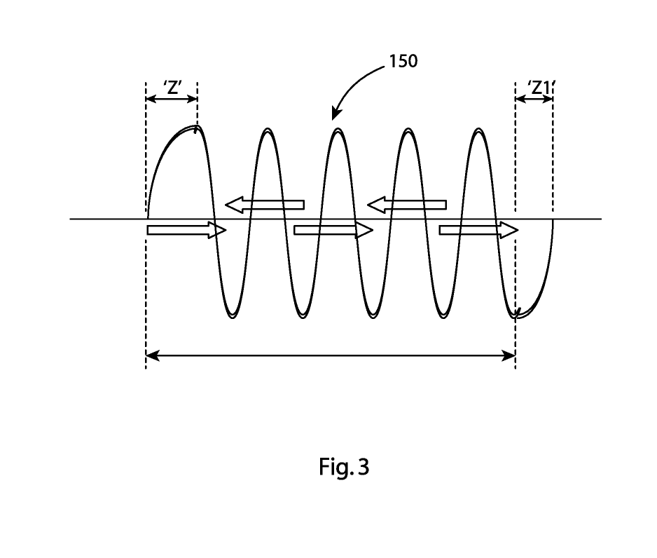

FIG. 2 shows the magnet of the generator of FIG. 1 as it has passed through the coil;

FIG. 3 shows an approximation of the sine wave measured for the generator of FIGS. 1 and 2 on an oscilloscope;

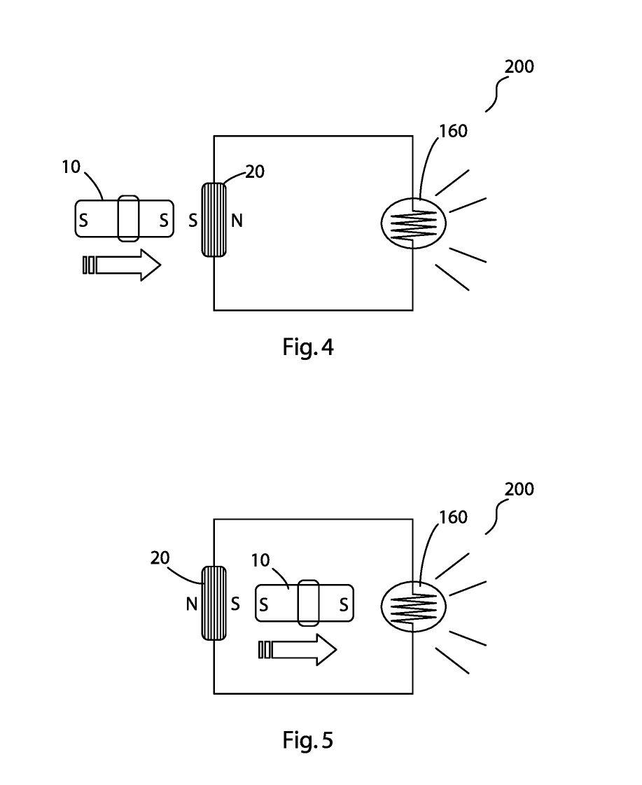

FIGS. 4 and 5 show a simplistic version of a generator according to the invention going through the same motion as the generator in FIGS. 1 and 2;

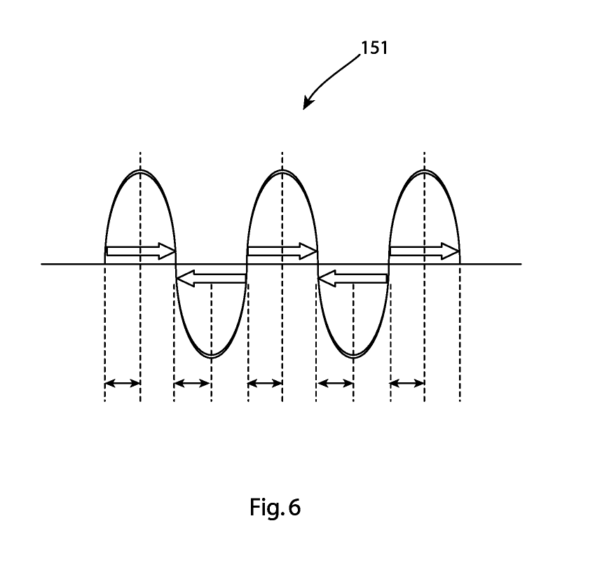

FIG. 6 shows an approximation of the sine wave measured for the generator of FIGS. 4 and 5 on an oscilloscope;

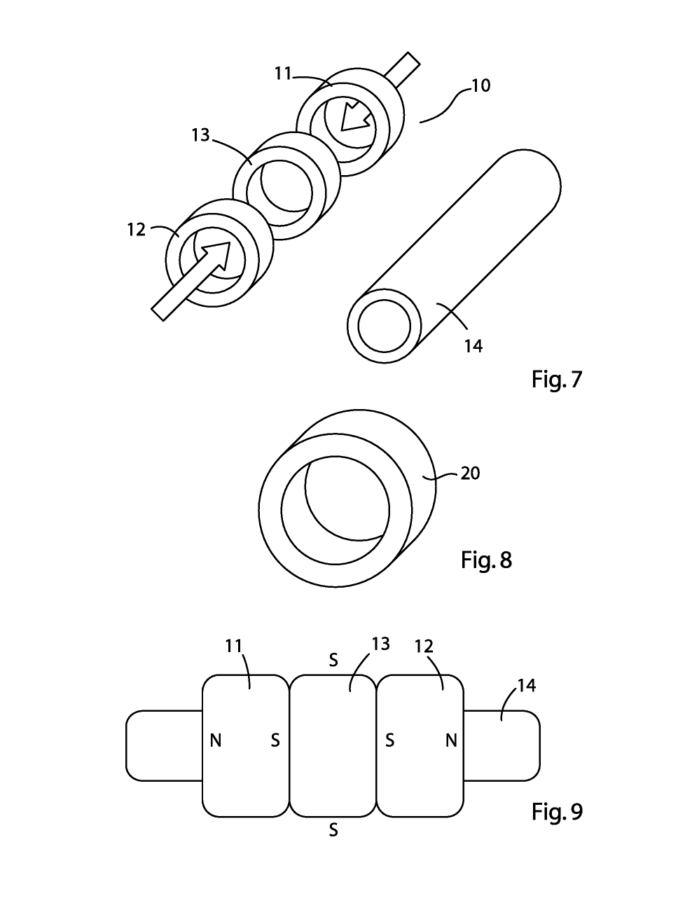

FIGS. 7 to 9 show a simple exploded version of a generator according to the invention that has relative motion between the exciter and the coil;

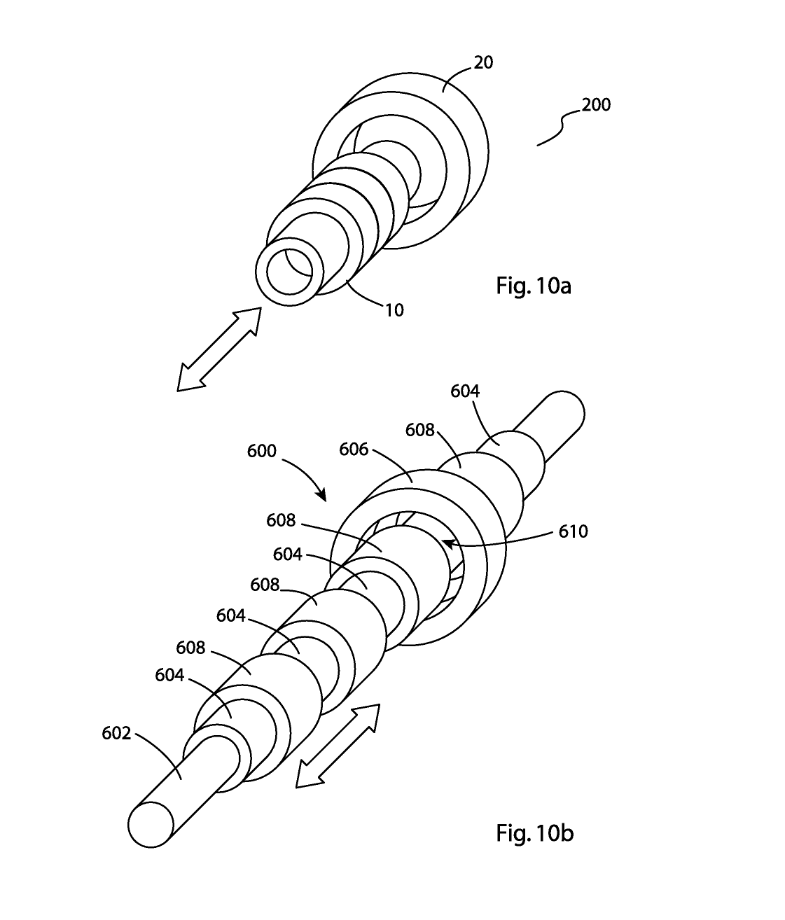

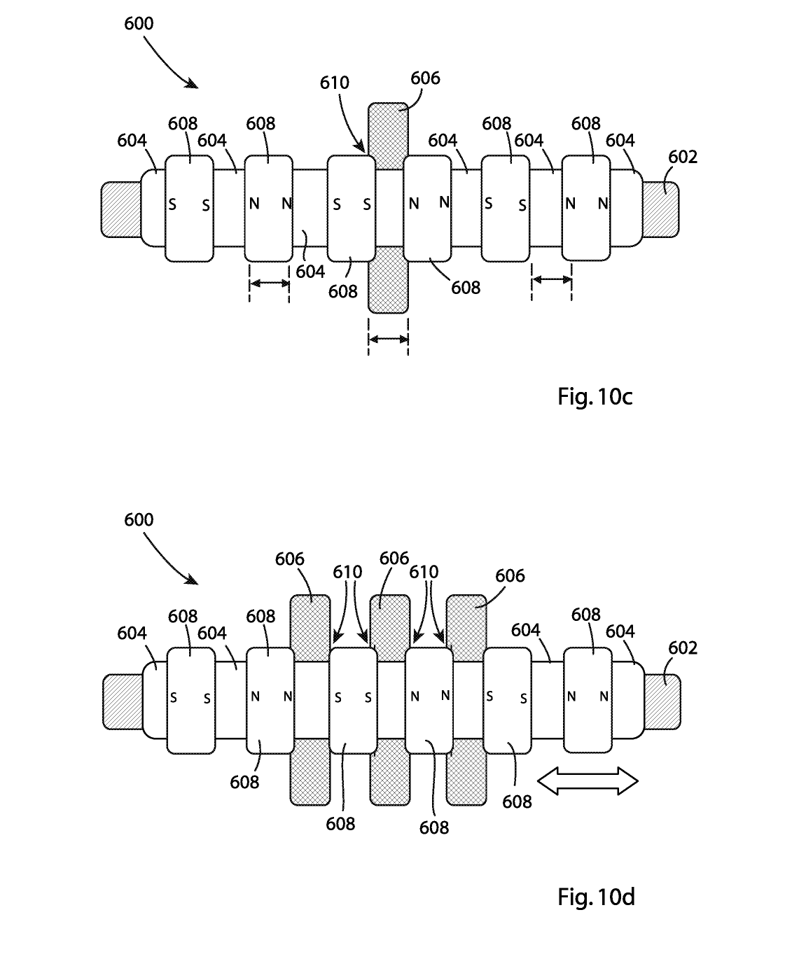

FIG. 10a to 10d show the construction (FIG. 7 to 9) and a simple working generator according to the invention that uses relative motion between the coil and exciter in a reciprocating stroke like manner;

FIG. 11 shows a multi poled magnet array and shoes of a multi-poled linear generator according to the invention where there is no relative motion between the exciter's mass and the coil;

FIG. 12 shows the windings required per pole for the generator of FIG. 11;

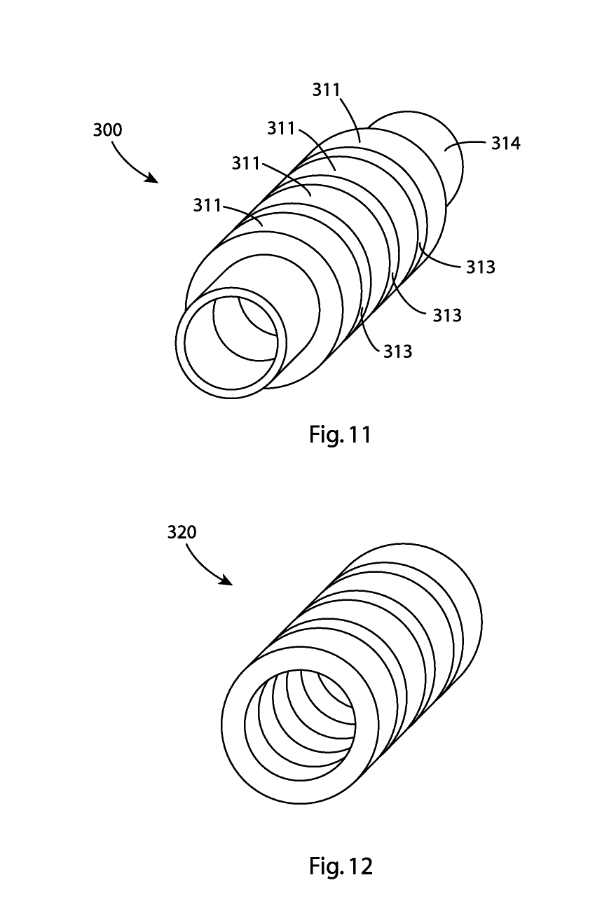

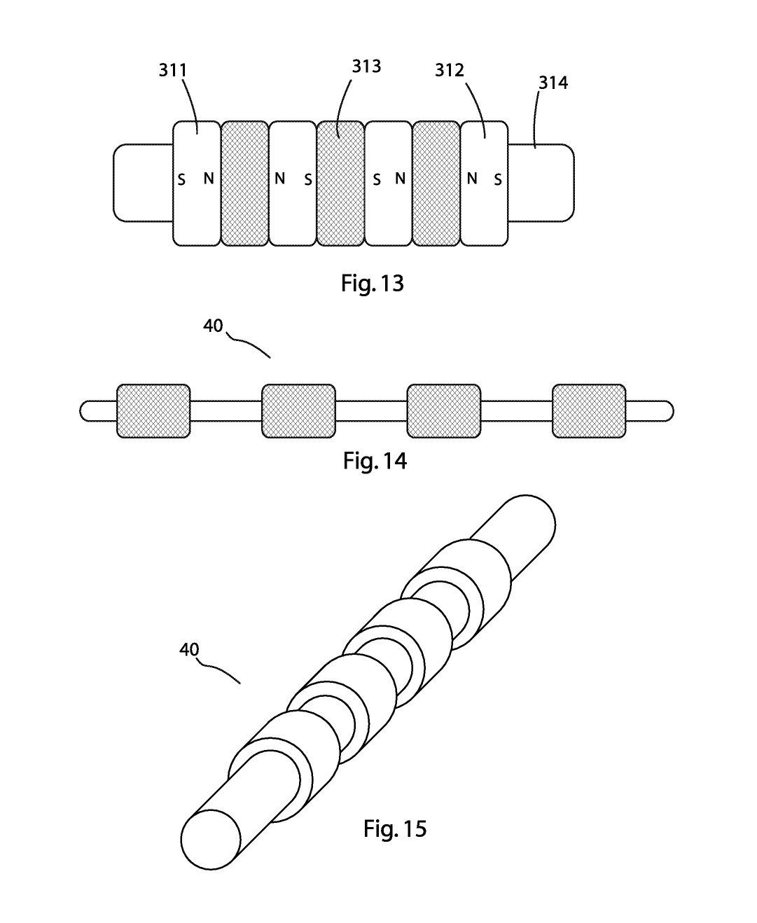

FIG. 13 shows the magnetic polarity of the exciter magnet array for the generator of FIG. 11;

FIGS. 14 and 15 show the translator for the generator of FIG. 11;

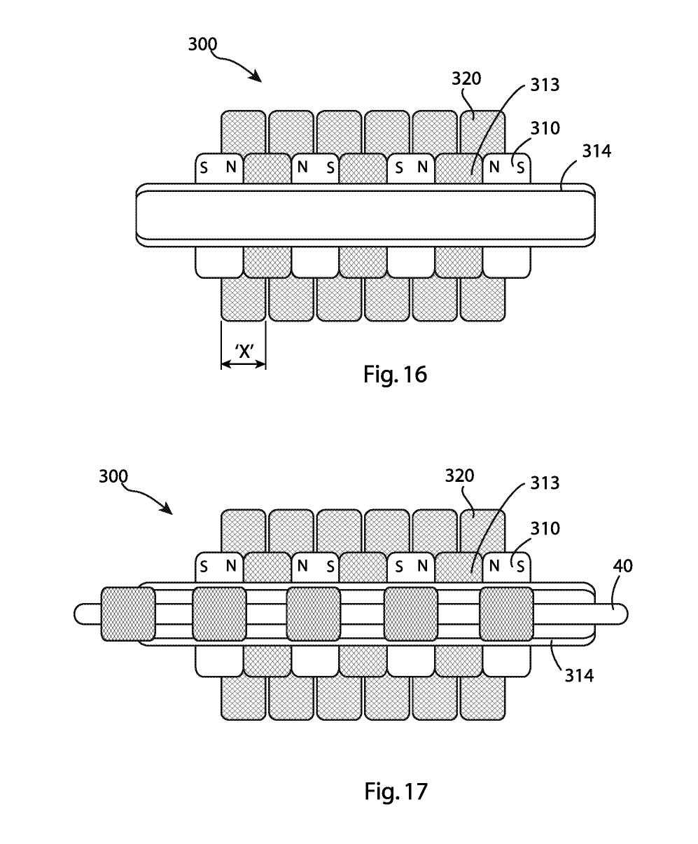

FIG. 16 shows a cross section of the generator of FIG. 11 without the translator in place;

FIG. 17 shows a cross section of the generator of FIG. 11 with the translator in place;

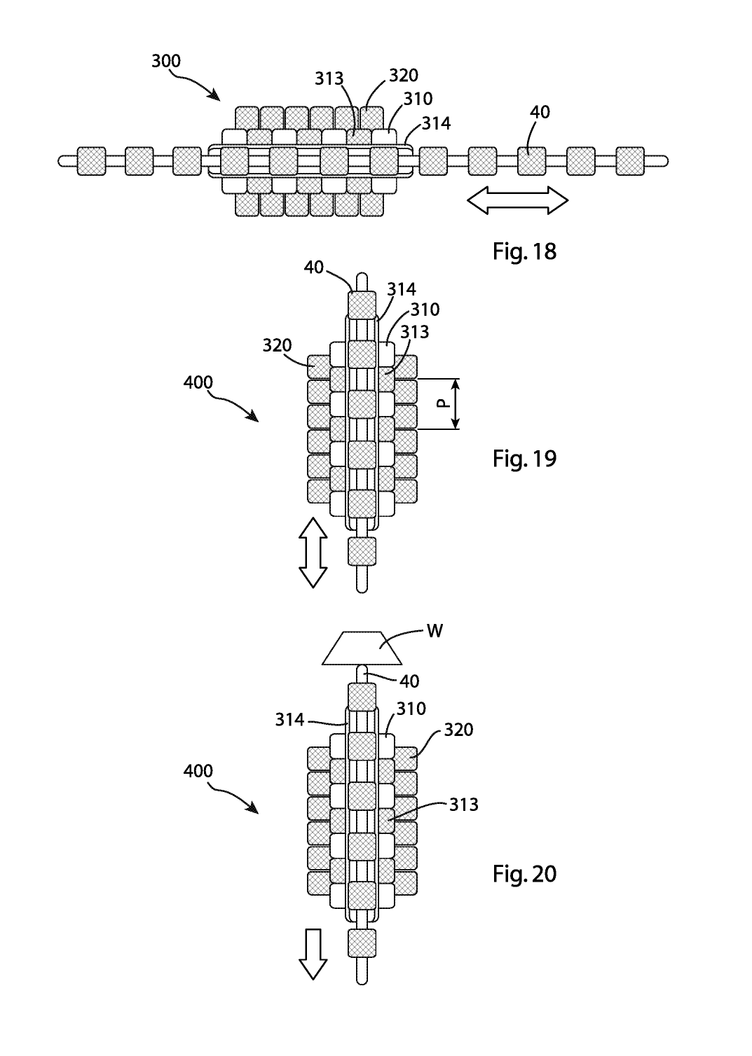

FIG. 18 shows a cross section of the generator of FIG. 11 with the translator in place and working;

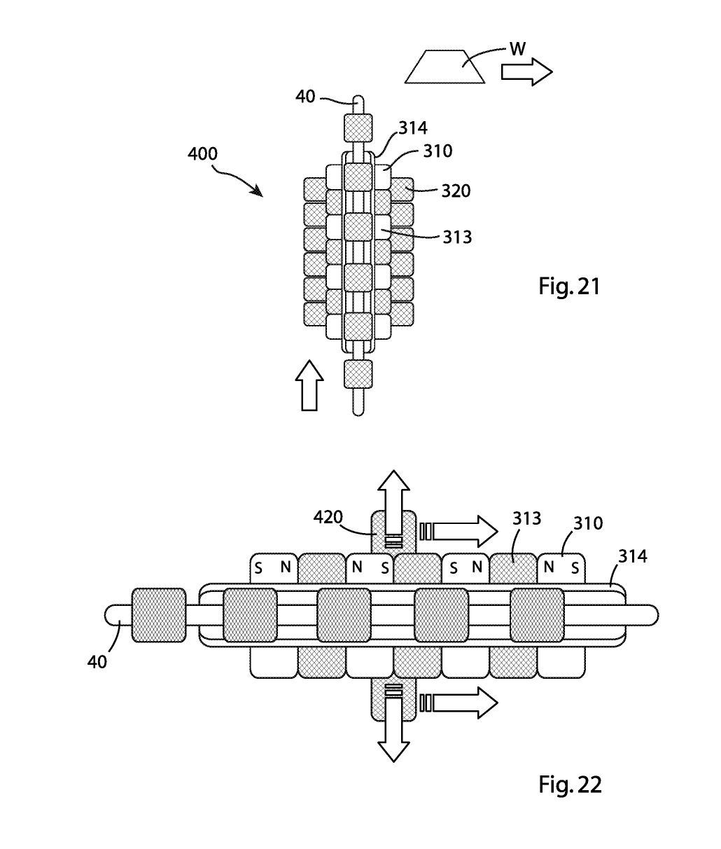

FIGS. 19 to 21 show an Inverted Hydro Generator according to the invention which is a version of the generator of FIG. 18 that is designed to move just under the distance of half a pole width in one direction;

FIG. 22 shows a flux being established in the winding as the flux expands outward through the winding;

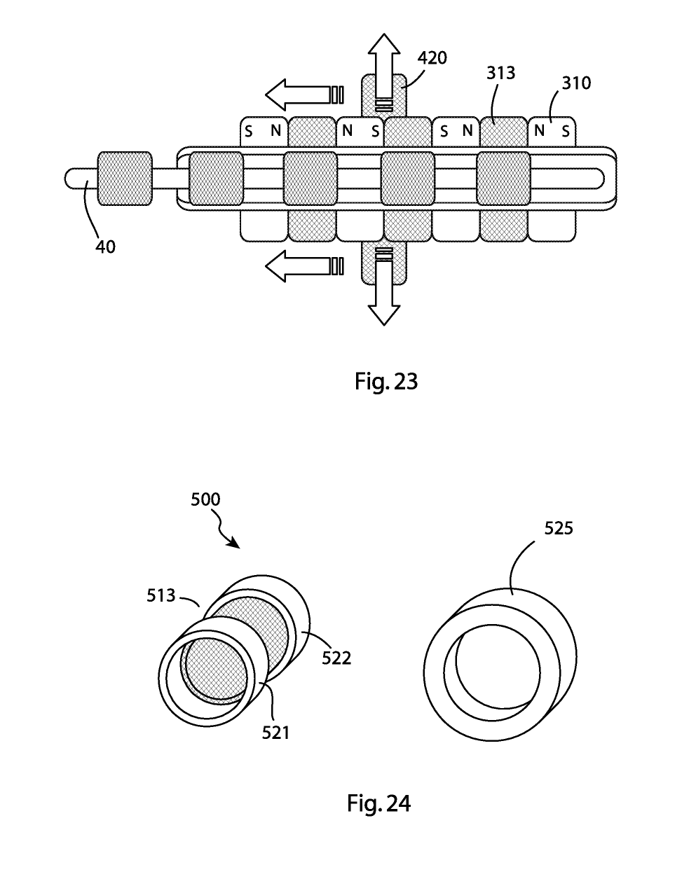

FIG. 23 shows the motion of the translator causing the original flux to recede or collapse through the winding;

FIGS. 24 to 27 show a transformer according to the invention;

FIG. 24 shows the components of the transformer of FIG. 23;

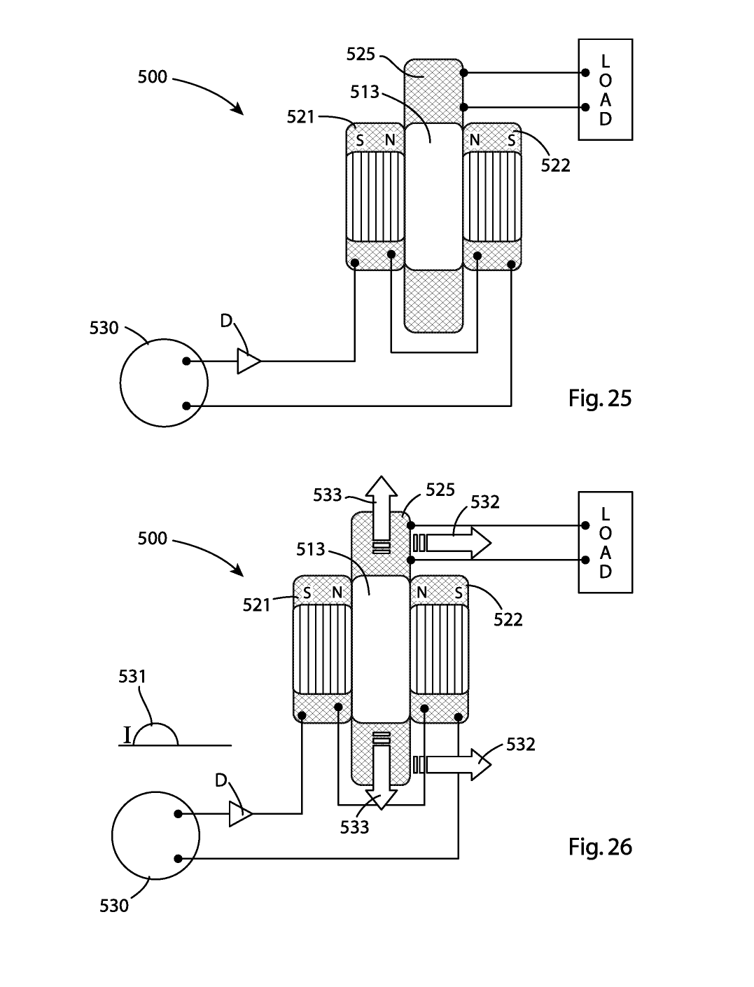

FIG. 25 shows a cross section of the transformer of FIG. 23 connected to an AC supply and the secondary connected to a load;

FIG. 26 shows flux established in the secondary winding of the generator of FIG. 23;

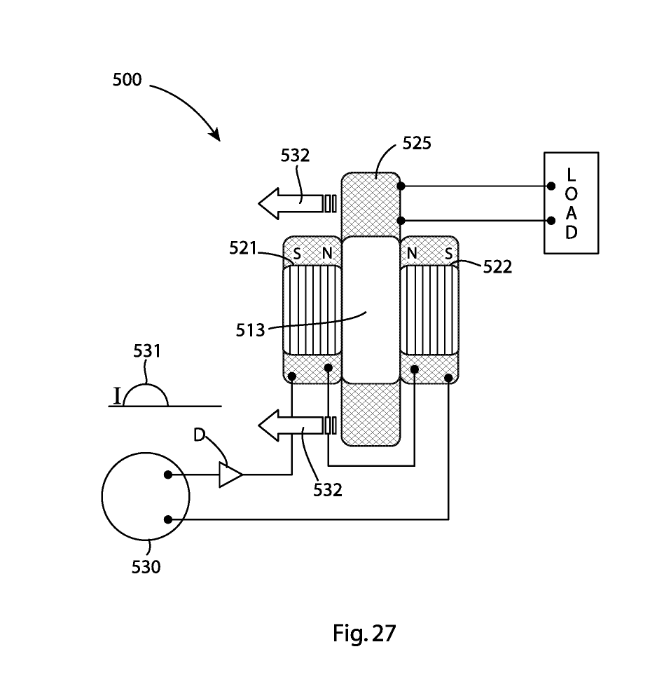

FIG. 27 shows the collapsing flux in the secondary is unopposed like the generator of FIG. 23;

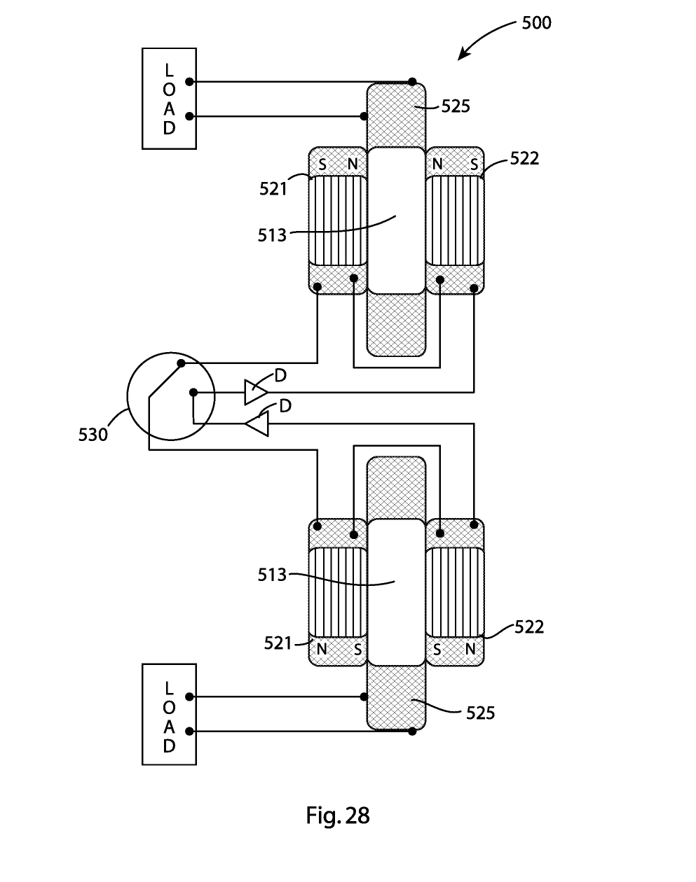

FIG. 28 shows a possible arrangement of the transformers of the invention which is ideal for connection to AC supply;

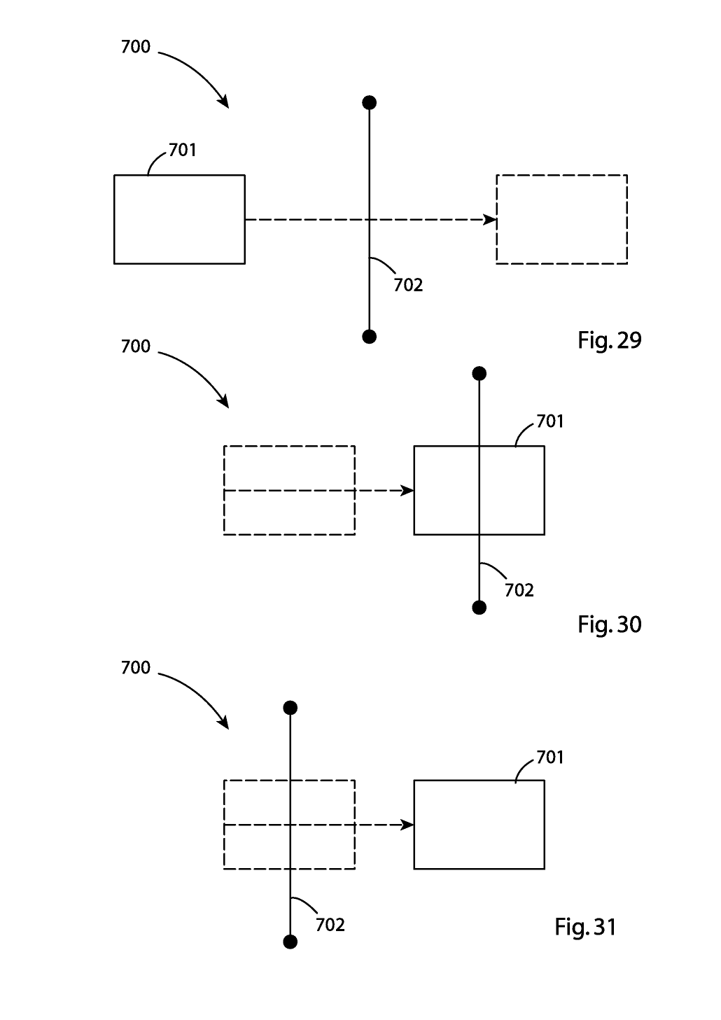

FIGS. 29 to 31 are block schematic diagrams showing the operation of a conventional generator;

FIGS. 32 to 39 show a rotary generator according to the invention;

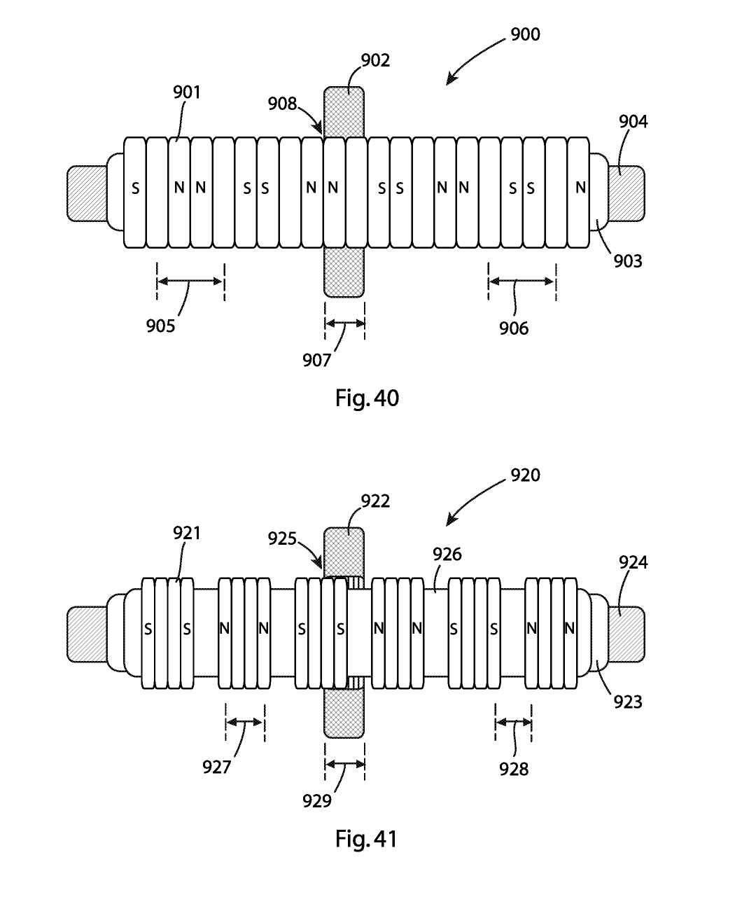

FIGS. 40 and 41 show configurations of exciters used in connection with comparative testing in connection with the present invention, and

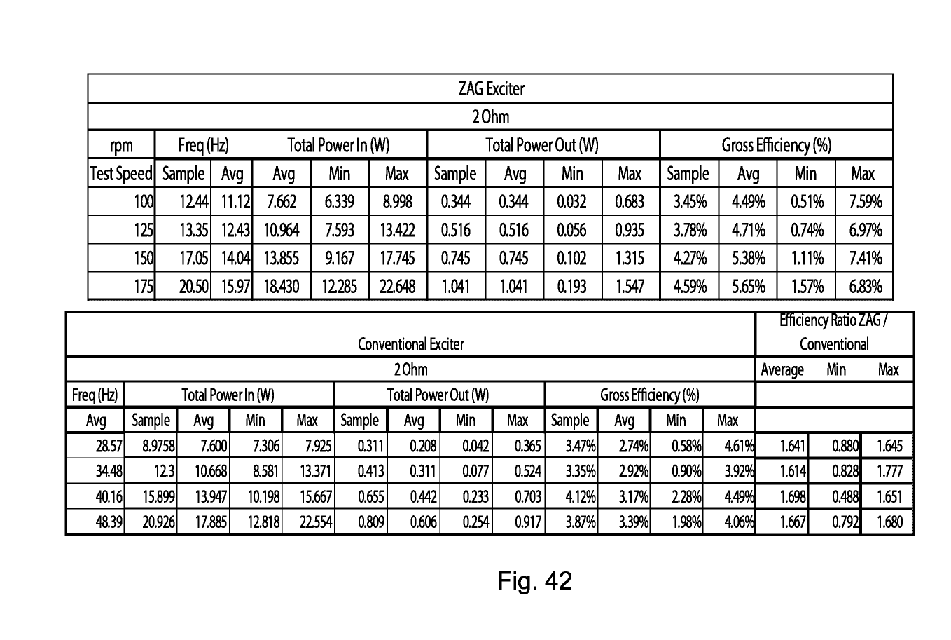

FIGS. 42 to 50 are tables showing gross efficiency results of tests performed in connection with the present invention based on the exciters shown in FIGS. 40 and 41.

Like reference numerals are used for like components.

Referring to FIGS. 1 and 2, there is shown a simple conventional generator 100. As the magnet 1 is moved toward the coil 2 (as depicted by the arrow), a magnetic field is set up in the coil that opposes the motion of the magnet. Mechanical energy is required to overcome this force and allow the magnet's motion to continue. Meanwhile an emf is generated in the coil 2. Bulb 160 is also shown.

FIG. 2 shows the magnet 1 as it has passed through the coil 2. The magnetic field in the coil 2 changes polarity and now opposes the magnet's motion by exerting a pulling force on the magnet 1. Mechanical energy is required to overcome this force and allow the magnet's motion to continue.

In FIG. 3, the conventional generator 100's voltage waveform 150 over five reciprocating strokes is shown. Larger arrows denote direction of stroke's motion. ‘Z’ and Z1 denote common characteristics shared by both the generator 200 according to the invention (see FIGS. 4 to 6) and the conventional generator 100.

Referring to FIGS. 4 and 5, a simplistic version of a generator according to the invention, denoted by reference numeral 200, is shown, with exciter 10 going through coil 20 with the same motion as magnet 1 in FIGS. 1 and 2. The exciter 10 of generator 200 is drawn in a simplistic form. As the exciter 10 is moved toward the coil 20 a magnetic field is set up in the coil that opposes the motion of the exciter. Mechanical energy is required to overcome this force and allow the exciter's motion to continue. Meanwhile an emf is generated in the coil 20.

As the moving exciter 10 passes the centre of the coil 20, the coil's flux begins to collapse. Unlike events seen in FIG. 2, this does not pull on the exciter 10. The moving exciter 10 can have no impact on the winding or the flux associated with it even though there is relative motion between these masses. There is no relative motion in the magnetic environment or between the flux associated with the coil 20 and the flux associated with the exciter 10. The coil's flux is allowed to collapse, no mechanical energy is derived from the supply to hamper this collapse.

In FIG. 6, the generator 200's voltage waveform 151 over five reciprocating strokes is shown. Larger arrows denote direction of stroke's motion. The double headed arrow represents work derived from mechanical supply.

Conventional generator 100 requires approximately twice the mechanical energy needed to facilitate the first half of its cycle (FIG. 1) per generated emf cycle (FIG. 3). Generator 200 requires only the mechanical energy to facilitate the first half of its cycle per generated emf cycle, as seen in FIG. 6.

Referring to FIGS. 7 to 10a, a possible arrangement for the exciter 10 in generator 200 is shown. Generator 200 has relative motion between the exciter 10 and the conductor 20. Exciter 10 consists of two ring magnets 11, 12 and an annular ferrous shoe 13. The ‘like’ poles of the magnets are faced onto the shoe. Non-ferrous mount 14 is also shown.

FIG. 10b shows a relative motion linear translator 600 passing through a single winding. Shown is a shaft 602, ferrous spacers or pole gaps 604, winding 606 and exciter poles 608.

FIG. 10c is a sectional view of FIG. 10b. Shown is a spooled winding 606, an air gap 610, a non-ferrous mount or shaft 602, ferrous spacers or pole gaps 604, exciters 608 and air gap 610.

FIG. 10d shows a relative motion linear translator 600 passing through a plurality of windings. Shown are spooled windings 606, air gaps 610, a non-ferrous mount or shaft 602, ferrous spacers or pole gaps 604 and exciters 608.

Referring to FIGS. 11 to 16, the components and construction of a multi-poled linear generator 300 is shown where there is no relative motion between the mass of exciter 310 and coil 320. Unlike the conventional linear generators 100 and in addition to the advantage of the generators 200 and 201 described herein, none of the primary components (magnets 311, 312 and windings 320) are ever redundant in this linear generator 300. Additionally, due the nature of this construction it is possible to fully protect the primary components (in epoxy resin etc.) making them impervious to moisture ingress etc. in a manner that is not possible with the conventional generator. There are also advantages in relation to flux linkage and no air gap is required between the exciter magnetic surfaces and the windings. Air gaps are usually significant in linear generators and represent a large redundancy in available flux.

Referring to FIGS. 14 and 15, the translator 40 for generator 300 is shown. This is preferably made from steel or another suitably ferrous material and can possibly be formed from one piece of material on a lathe or similar. Where the larger outer diameter of the translator 40 lies across two pole shoes 313, the magnetic flux associated with these shoes is collapsed or compressed, however the magnetic polarity never changes. Where the inner diameter of the translator lies across two shoes the flux associated with these shoes is ‘expanded’ outward through the winding 320. Where motion of the translator 40 causes the flux in across two neighbouring poles shoes 313 to collapse, the poles immediately to each side of this will expand and so on throughout the length of the generator 300. Again, there is no energy required from the supply per half cycle (approx).

FIG. 18 shows a cross section of the generator 300 with the translator 40 in place and working. Where the larger outer diameter of the translator 40 lies between two of the generator shoes 313, the flux extended through the coil 320 is collapsed through the coil 320. The flux through the windings on either side of this will be expanded through the coil 320. Motion of the outer diameter of the translator away from between two shoes 313 causes the flux to expand outward and through the coil 320. Where this motion exceeds slightly over a pole width P, the translator tends to ‘jump’ to fall between the pole shoes 313 again. An emf is generated in both parts of this cycle.

The forces exerted on the translator 40 are considerable. With a generator body the length of a hand constructed from 25 mm id, 40 mm od neodymium magnets constructed in this manner it will be difficult if even possible to drive the translator 40 by hand.

Unlike conventional linear generators 100 none of the exciter 310 or the windings 320 are redundant while the generator 300 is being operated.

The stroke length is defined only by the inexpensive translator 40 not the exciter 310.

Referring to FIGS. 19 to 21, an Inverted Hydro Generator 400 is shown which is a version of generator 300 designed to move just under the distance of half a pole width in one direction. Energy stored in the magnetic flux and magnetic circuitry is then fired in the opposite direction, this storage of energy and ‘firing’ can be further added to with a spring or similar. This restriction of motion can be imposed by the mechanical supply. This cycle should occur in rapid succession. Specifically this generator 400 was designed for the purpose of Inverted Hydro as described earlier in this document. Generator 300 can also fulfil this purpose.

The winding's width cannot exceed the pole width as denoted by ‘x’ in FIG. 16.

The Inverted Hydro generator 400 is fired when the weight W is removed or displaced. This design is mostly intended for the conversion of large volumes slow moving tidal water to electrical energy. The energy stored does not so much relate to the horizontal flow of the water, though this is required, but an energy at right angles to this, mass*gravity. There are various means to achieve this and only the nature of the electrical generator required is described herein.

FIG. 22 represents the part of the cycle where mechanical energy is derived from the supply. A flux is established in the winding 420 as the flux expands outward through the winding.

The motion of the translator 40 as shown in FIG. 23 causes the original flux to recede or collapse through the winding 420. In this part of the cycle no mechanical energy is required.

Referring to FIGS. 24 to 27 a transformer 500 is shown, the construction is not unlike the generators 200, 300 and 400 described and like reference numerals are used for like components.

Referring to FIGS. 25 to 27, shown is a primary consisting of two windings 521, 522 connected in series, optional ferrous shoe 513, a secondary winding 525, an A/C supply 530, a diode ‘D’ on the ac supply 530 operable to only allow the current through the primaries to flow in one direction only, and the magnetic polarity of the primary and associated magnetic circuitry must not be capable of reversing. As with the generators 200, 300, 400 the like pole of each winding is faced onto the ferrous shoe 513. Also shown is supply current 531, polarity and motion of the primary flux 533, and the polarity and motion of the secondary flux 532. In the instance shown, the primary's flux is caused to move outward through the secondary winding in the direction shown generating a magnetic flux in the secondary.

As shown in FIG. 26, when the flux has peaked and the supply current changes direction the primary winding becomes an open circuit because of the diode. Therefore the collapsing flux through the secondary is not opposed by a flux related to the primary since being open-circuited the primary winding can have no flux in this part of the cycle. Where there is no current flowing in the primaries, they are open circuit, the collapsing flux in the secondary is unopposed.

As shown in FIG. 27, after the secondary's flux 532 has peaked the secondary's flux 532 is collapsing and its magnetic polarity reversed. Due to the diode and change in direction of the supply current the primary is an open circuit. In this duration or part of the cycle, the secondary's flux is independent of the supply and the primary has no flux to oppose the secondary flux.

Shown in FIG. 28 is a possible arrangement for a transformer best using the supply energy, such as when connected to a domestic electrical supply. As shown, the arrangement in FIG. 26 will be connected to the electrical supply and then disconnected for the same duration. This process repeats (at very high speeds). This means the supply energy is idle half of the time. The arrangement provided in FIG. 28 ensures that when one of the transformers becomes disconnected from the supply the other will automatically become connected to the supply. The supply energy is continuously working and even though the transformers are disconnected from the supply per half the supply ac cycle their outputs are continuous and uninterrupted.

Referring to FIGS. 29 to 31 are block schematic diagrams showing the operation of a conventional generator.

Faraday's Law describes two events (affect) manifested over a sum duration that exceed the duration of the event that caused these (causality). The sum duration of the manifested events (affect) is always greater than the duration of the first event (causality). Normally, though not always, the duration of affect is twice that of causality. Traditionally, the electromagnetic generator ‘works’ to establish a flux in its conductor. Once this flux is established in the conventional generator's conductor the design is such that further ‘work’ is introduced into the system to act (oppose the collapse of) against what is a previously generated stored energy causing an unnecessary inefficiency in these systems. Conventionally generators work on some variation of the following basic principle that should be considered in two parts:

First part of this magnetic cycle: A magnet/exciter approaches a conductor until it centres it. Second part of this magnetic cycle: The magnet/exciter moves away from the conductor.

FIGS. 29 to 31 show a simple conventional generator 700, after start-up and in motion, where the exciter 701 has a constant velocity relative to the conductor 702, the load is fixed and the distance to and away from the conductor 702 depicted is equal, as shown in FIG. 29.

Ignoring losses and with respect to the required mechanical and generated electrical energies, in the first part of the magnetic cycle, or where the exciter 701 approaches the conductor 702 to the point where it centres the conductor 702, as shown in FIG. 30: (Required mechanical energy=‘A’ and the generated electrical energy=‘X’. Therefore ignoring losses: (input energy ‘A’)=(output energy ‘B’)

Ignoring losses and with respect to the required mechanical and generated electrical energies in the second part of the magnetic cycle or where the exciter now moves away from the conductor's centre having an equal travel and velocity, as shown in FIG. 31, as it did on its previous approach toward the conductor: (Required mechanical energy=‘B’ and the generated electrical energy=‘Y’. Therefore ignoring losses: (input energy ‘B’)=(output energy ‘Y’)

With respect to Conservation of Energy and Cause and Affect this is deemed to be as follows: Assuming no losses to heat etc: The input energy and sum of causality is (A+B). The output energy and sum of affect is (X+Y). Therefore: (A+B)=(X+Y).

In the described scenario in terms of energy we can also say (A=B=X=Y). The difficulty is that the equation (A+B)=(X+Y) cannot be reconciled with Conservation of Energy or Cause and Affect and also represents a failure to correctly interpret Faraday's Law.

The reason being ‘B’ is not the input energy we believe it to be. ‘B’ is a generated output energy derived from previously generated energy in the generator manifested as a mechanical energy.

‘B’ is deprived from contributing to the electrical output to instead oppose the supply energy. To reconcile the above described generator with Conservation of Energy then: ‘A’, the input energy and causality=(X+Y+B) the sum of affect and generated output energies. Therefore: ‘A’=(X+Y+B).

With respect to time: The relationship between Cause and Affect is not instantaneous but semi-instantaneous. Where the exciter/magnet approaches until it centres the conductor, there are two consequences of this: For the duration of this relative motion and instantaneously an emf is manifested in the conductor. Simultaneously a potential energy is stored in the spring-like magnetic flux quality equalling the emf being manifested in the conductor.

This stored energy is not however manifested as emf in the conductor in this duration. With conventional systems after the flux has been established in the conductor the release of the stored energy imparted by the collapsing flux this is opposed by allowing this interact with the supply energy causing two unnecessary primary inefficiencies. (There are further secondary inefficiencies derived from this that relate to the characteristic of the magnetic flux and its relationship with the mass it is coupled or interacts). Firstly, this energy unnecessarily opposes the supply energy and secondly it is therefore deprived from facilitating the intended/emf output.

This is comparable exerting energy to compress a spring for the purpose of driving/moving a load, then when releasing the spring's energy, the force that first caused this compression again acts against the release of the spring's energy in turn reducing the energy available to be imparted on the load. The resolution of these primary inefficiencies will have a two-pronged advantage and also eradicate the secondary inefficiencies. No longer being opposed by a previously generated energy the input energy will be lessened while simultaneously the stored generated energy that normally acted against the supply will now facilitate only the output, therefore the output energy will be increased.

According to a generator configured according to the present invention, the flux is established in the generator's conductor in the same way as it is with the conventional electromagnetic generator. According to the present invention, once the flux is established or peaks in the conductor due to the motion in the first part of the magnetic cycle, relative motion in the conductor/magnetic environment must cease until all of the stored energy is manifested in the conductor as emf. That is for the duration it takes this previously established flux to collapse through the conductor. In affect this means that during this second half of the (or second) magnetic cycle the generator must be independent off or disengage the supply energy. Once the conductor's flux has fully collapsed this magnetic cycle repeats.

Motion between the mass associated with the magnetic environment relative the conductor's mass does not necessarily imply relative motion in the conductor/magnetic environment. The reverse also being true. It is important to differentiate between these two separate relative motions that occur within electromagnetic devices.

According to a relative motion generator configured according to the present invention, in the first part of the cycle where the flux is being established in the winding there is motion of the mass associated with the magnetic environment relative to the mass of the conductor. There is also relative motion in the conductor/magnetic environment. (These motions are not equal).

In the second part of the cycle where the flux is in collapse through the winding there is motion of the mass associated with the magnetic environment relative to the mass of the conductor. There is however no relative motion in the conductor/magnetic environment. Accordingly, generators, motors and transformers configured according to the present invention, are designed such that a flux collapsing through their relevant conductors can never oppose the supply energy but is instead diverted to facilitate the intended output be that mechanical or electrical.

FIGS. 32 to 39 show a rotary generator according to the invention.

FIG. 32 shows an alternating rotor, single phase rotary generator 800 according to the present invention. The generator comprises two windings, 801, 802 that may be connected in series or parallel, whereby the output windings polarity alternates at right angles to the horizontal plane indicated by the reference 805. Also shown is a centre of winding 804, and an electromagnetic rotor 803, which may be brush or brushless. Windings 801, 802 lie diametrically opposite the stator's length.

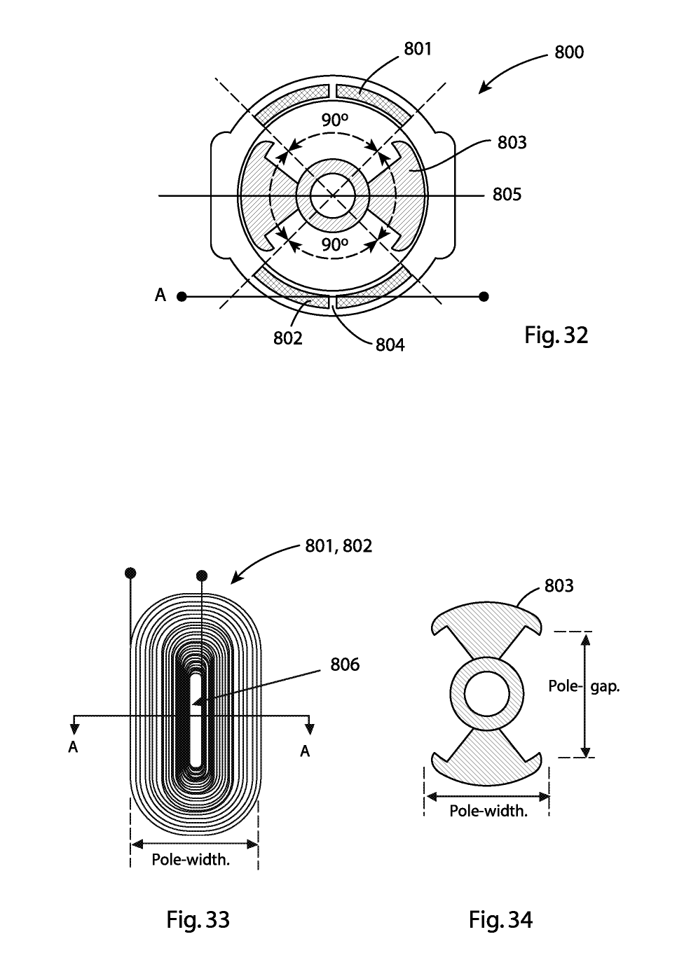

FIG. 33 shows a cross section of windings 801,802 along the line indicated by the reference numeral ‘A’ with a minimal gap 806.

As shown in FIG. 34, the rotor 803 and windings 801, 802 should have an equal pole width.

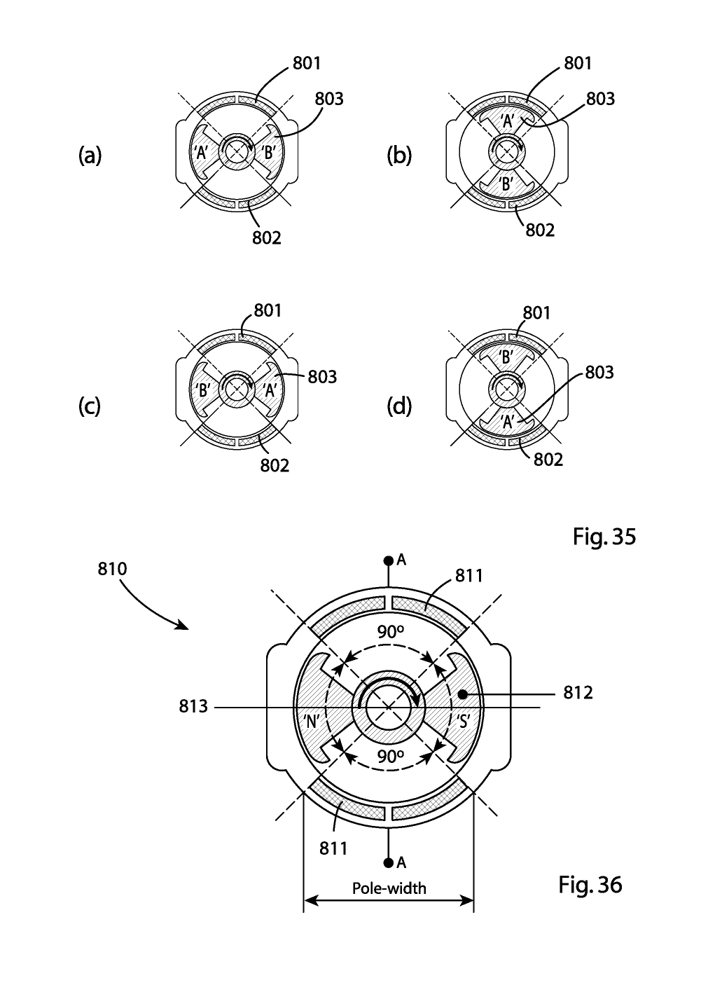

FIG. 35 shows the magnetic polarity of the rotor 803 at respective angles, whereby for the specific design shown the magnetic polarity, A and B, of the rotor 803 alternates at 90 degree intervals. In FIG. 35(a) the rotor 803 is shown 0 to 90 degrees past the horizontal (‘A’ denotes North and ‘B’ denotes South); FIG. 35(b) the rotor 803 is shown 90 to 190 degrees past the horizontal (‘B’ denotes North and ‘A’ denotes South); FIG. 35(c) the rotor 803 is shown 180 to 270 degrees past the horizontal (‘A’ denotes North and ‘B’ denotes South), and in FIG. 35(d) the rotor 803 is shown 270 to 0 degrees past the horizontal (‘B’ denotes North and ‘A’ denotes South).

On entering the winding and until a flux is fully established in the winding (0 to 90 degrees and 180 to 270 degrees) this is the same as with any other electromagnetic generator.

After the flux is established, in the above example at 90 degrees and 270 degrees, it must then be allowed collapse unimpeded by the supply energy. There are several ways this can be achieved.
1. A diode can be connected across the rotor exciter winding/s. As the rotor centres the winding at 90 degrees and 270 degrees the supply energy is disconnected from the rotor. The current is then allowed to flow via the diode(s) in reverse through the rotor winding/s reversing its magnetic polarity.
2. An alternating supply feeding the rotors winding is synchronised to cause the rotor's polarity to alternate as appropriate. Even though the rotor is connected to the supply energy, no work will be derived from this during the collapse of the flux in the field winding, as there is no relative motion between the field windings flux and the rotor's flux.
3. A less efficient alternative is that as the rotor centres the winding at 90 degrees and 270 degrees the supply circuit to the rotor is caused to open circuit for the next 90 degrees, simultaneously causing the rotor's exciter winding(s) to become open circuited for the same duration. This also requires an additional consideration of the continuing flux associated with the rotor's magnetic circuitry.

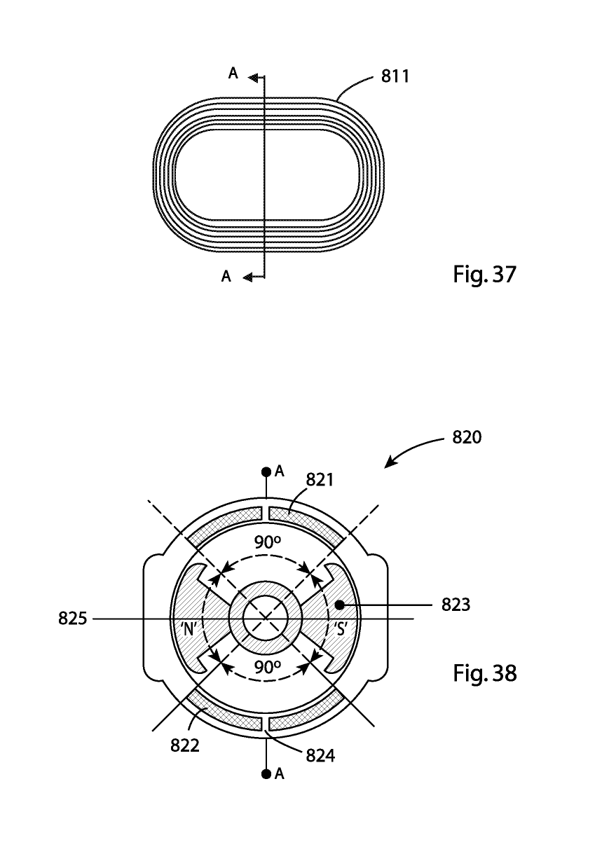

FIG. 36 shows a single phase rotary generator 810 with one output winding 811. Rotor 812 rotates within the winding 811 and has fixed polarity. Rotor 812 may be a permanent magnet of fixed pole electromagnetic rotor, brush or brushless, and the polarity of the output winding alternates parallel to the line 813. FIG. 37 shows a sectional view of fixed rotor single winding 811.

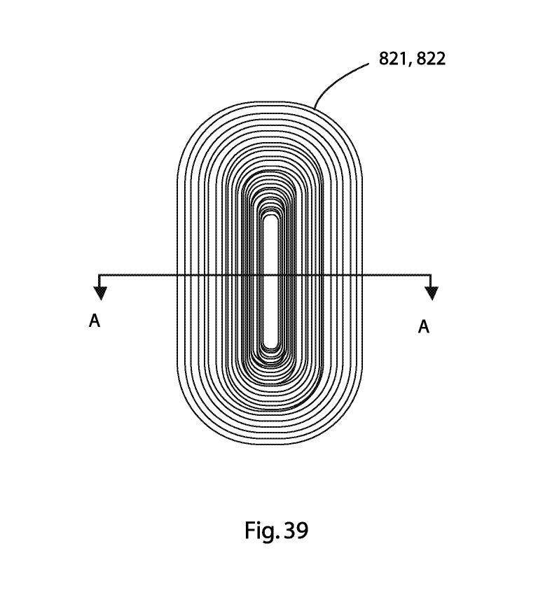

FIG. 38 shows a single phase or DC rotary motor 820 with two input windings 821, 822 that may be connected in series or parallel. Also shown is electromagnetic brush or brushless or permanent magnet armature/rotor 823. A centre of winding 824 is also shown. The polarity of the output winding alternates parallel to the horizontal plane 825. Motor windings 821, 822 are connected in series or in parallel. Alternating magnetic flux is at right angles to the plane 825. FIG. 39 is a sectional view of the windings 821, 822.

On entering the winding and until a flux is fully established in the winding (0 to 90 degrees and 180 to 270 degrees) this is the same as with any other electromagnetic generator. With the motor shown in FIG. 38 the field winding is energised by a dc supply pulling the rotor from 0 to 90 degrees and 180 to 270 degrees. Where the rotor centres the winding at 90 and 270 degrees the supply energy is disconnected. At this point through a diode on the field winding the current is allowed to reverse through the supply winding reversing its magnetic polarity. For the next 90 degrees (to 180 and 0 degrees) the input winding repulses the rotor independent of the supply energy.

FIGS. 38 and 39 shows a two-spoke-rotor in which the rotor rotates within the winding and the spoke of the rotor should occupy 90 degrees and the space between each rotor-spoke should also be equal to this 90 degrees, as drawn. Where there are two in phase windings and four rotor spokes these widths must be proportionately decreased. The other winding shown lies parallel to the rotor's motion. In this case the spoke's pole width is equal the full width of the winding, the space between each winding is also equal this pole-width. For example a system having three windings and three rotor spokes would have a pole width of 60 degrees, windings occupying and offset by 60 degrees. Poly phase systems would differ only in the spacing between the windings.

FIGS. 40 to 50 show the results of an efficiency and power quality study of a prototype linear generator according to the present invention. The theoretical concept behind the the linear generator of the present invention suggested that the design should be considerably more efficient than a conventional exciter design, as there is no loss involved in bringing the EMF to zero. This increased efficiency claim was to be verified/disproved through the following testing. The test program sought to compare the efficiency of the prototype linear generator according to the present invention with a conventional Halbach design and analyse the difference in waveforms. The test involved the stator coil being propelled a drive motor. The reduced load on the motor, reduced friction losses and equalized weight distribution from the redesign provided a more realistic efficiency evaluation for both generators.

The study was undertaken in a series of logical measurement and steps using advanced power analysis equipment for low power applications (Newton's 4^{th} PPA5530 3 Phase Power Analyser), a high bandwidth digital oscilloscope (Tektronix TDS3014B Oscilloscope) and precision bench metering (Agilent 34401A Multimeter). Test speeds were measured using an RS 163-5348 Digital Photo/Contact tachometer.

The test rig consisted of a 12 Volt DC motor and gearbox powered by 0-30V, 0-12 A Power Supply which provided rotational motion to a cam system. Conversion of the rotational motion to linear motion was achieved via a piston connected to a plastic casing, containing the output coil (stator), freely supported by two tracks on either sides of the magnetic exciter. This was the second iteration of the test rig design; the first involved the propulsion of the heavier exciter via a heavier steel cam disk. The earlier design had issues with high levels of vibration, variation in friction due to positioning of magnetic poles and lubricant viscosity changing with temperature.

Limitations include reduced stroke length—the test rig was limiting the stroke length to less than the length of the full exciter. For both exciters the stator (coil) intercepted a non-integer number of poles, leading to waveform distortion at both ends of the movement cycle. This affects the exciter according to the present invention and the conventional Halbach exciter differently due to the number of poles intercepted in each stroke. The exciter of the present invention has 6 poles cut by the coil during one forward stroke of the coil. In contrast, due to the lack of gaps in the Halbach design, 13 poles were cut by a forward stroke of the coil during actuation. Therefore the present invention exciter results are impacted disproportionately as 33% of the present invention generator poles are affected as opposed to 16% of the Halbach poles. Additionally, velocity variation—the linear motion conversion method does not provide a constant velocity throughout the stroke. This is due to the cam mechanism attempting to replicate Simple Harmonic Motion. The waveform amplitude peaks in the middle of the stroke, where the velocity is maximum, and decays at both ends, where the velocity falls towards zero at the turning point. This issue appears for both exciters, therefore it does not impact the results significantly

The basis of the test is to compare the performance of two exciter designs, namely a conventional Halbach exciter 900, as shown in FIG. 40, and an exciter 920 configured according to the principles of present invention, and as shown in FIG. 41. It will understood that the specific configuration of the exciter of FIG. 41 is shown by way of example only in order to demonstrate the efficiency of the present invention, and the specific configuration should therefore in no way be seen as limiting.

Shown in FIG. 40 is the first exciter design, which is a standard “Halbach” exciter 900 constructed out of a series of ring magnets 901. The Halbach array is based upon the concept of controlling the direction of magnetic fields by arranging magnets 901 in a particular order. The concept was originally used to focus particle accelerator beams.

In this exciter 900, the magnets are arranged in groups of four to produce alternating North and South poles with no gaps. This means that the field will overlap from North to South pole and the stator coil 902 will suffer magnetic friction as it moves directly from one pole to the next. The coil 902 is engineered to be the same width as each of the poles to ensure a uniform waveform. Also shown is aluminium exciter mount 903 and non-magnetic rail shaft 904. The North magnetic pole width 905 is 15 mm and the South magnetic pole width 906 is 15 mm. The width 907 of winding 902 is 15 mm, with an inside diameter of 42 mm and an outside diameter 80 mm. Air gap 908 is also shown.

The modelled magnetic field for the Halbach exciter was produced in FEMM. This confirms how the field overlaps from each North to South pole as expected. As a result the change in flux will be more sinusoidal in natural. The only difference between the model and the real construction is that B42 magnets were used in the prototype due to availability rather than the B40 magnets modelled in FEMM. As there is no separation between the poles and the coil is approximately the same width as a full pole, the Halbach will experience a differential flux at both ends of the coil when the coil is moving between a “North” and “South” pole. As a result, the rate of change of the resultant flux density will determine the magnitude of the voltage.

Shown in FIG. 41 is the design of an exciter 920 embodying the present invention. Shown are magnets 921, coil winding 922, aluminium sleeve 923, stainless steel non-magnetic shaft 924, ferrous spacers 926 between magnets 921, and air gap 925. The magnetic pole width 927 is 15 mm. The width 929 of winding 922 is<15 mm, with an inside diameter of 42 mm and an outside diameter 80 mm. Each ferrous spacer 926 has a width of 13 mm with an inside diameter of 25 mm and an outside diameter of 30 mm, and a magnetic pole gap width 928 of 17 mm.

The design works on the basis of elimination of the magnetic friction caused by overlapping magnetic fields between the poles and by not storing energy in the coil like the Halbach arrangement shown in FIG. 40, which is achieved by using the same magnets while spacing the poles apart slightly less than the width of the coil. By doing this, the coil is only affected by the flux density of one pole at a time, meaning the rate of change of flux is more extreme. The pole spacing is maintained by ferrous spacers that prevent the magnets from attracting/repelling one another while also absorbing any stray magnetic flux. The magnetic field behaviour for this design was also simulated in FEMM. The resulting flux density is contained primarily to the pole with almost zero flux density in the gaps. This would suggest that the change in magnetic flux will be steeper leading to a larger emf being produced. The aim of testing is to prove whether this results in higher efficiency for the user.

The results of testing show that the exciter of the present invention was 15% to 60% more efficient (gross efficiency) than the conventional Halbach generator (output power versus input power when powering a load) over all loads and speeds. Comparison of the results from the oscilloscope (which allowed the efficiency for the undistorted section of the waveform to be analysed) showed an improved gross efficiency of between 12%-70% over the loads and motor speeds tested using the exciter of the present invention. This is lower than the assumed theoretical increase in efficiency laid out concept document issued for the generator of the present invention, however does show that there is a benefit in using the exciter of the present invention over a conventional Halbach design.

The primary reason identified for this increased efficiency is the greater emf amplitude produced by the prototype exciter of the present invention when the stator is driven at the same speed. This in turn produces a higher current for a given load effecting in higher output power. Due to the spacing of the magnetic poles on the exciter, the electrical frequency is roughly half of the conventional exciter, which may be an issue for some applications.

A breakdown of all test results are presented in the tables of FIGS. 42 to 50, in which the test results of the exciter of the present invention are referred to as “ZAG exciter”, and the test results of a conventional Halbach exciter are referred to as “Conventional exciter”.

FIGS. 42 to 46 are tables showing the gross efficiency test results (PPA5530 Power Analyser) for the exciter of the present invention and the Halbach exciter.

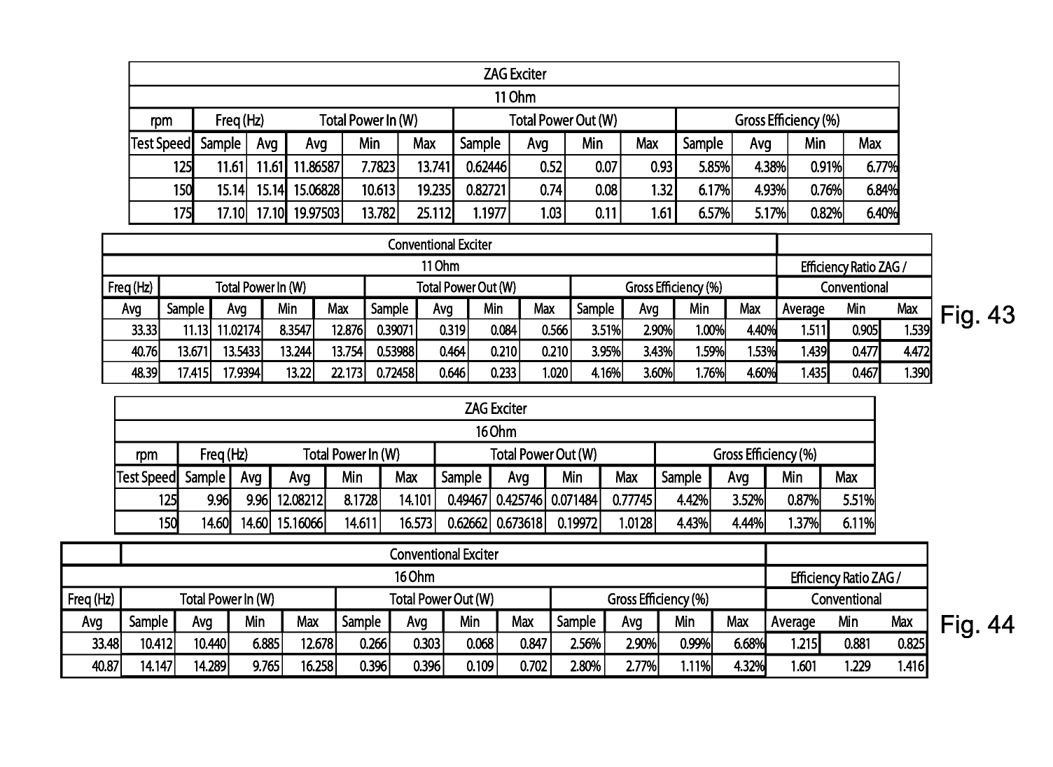

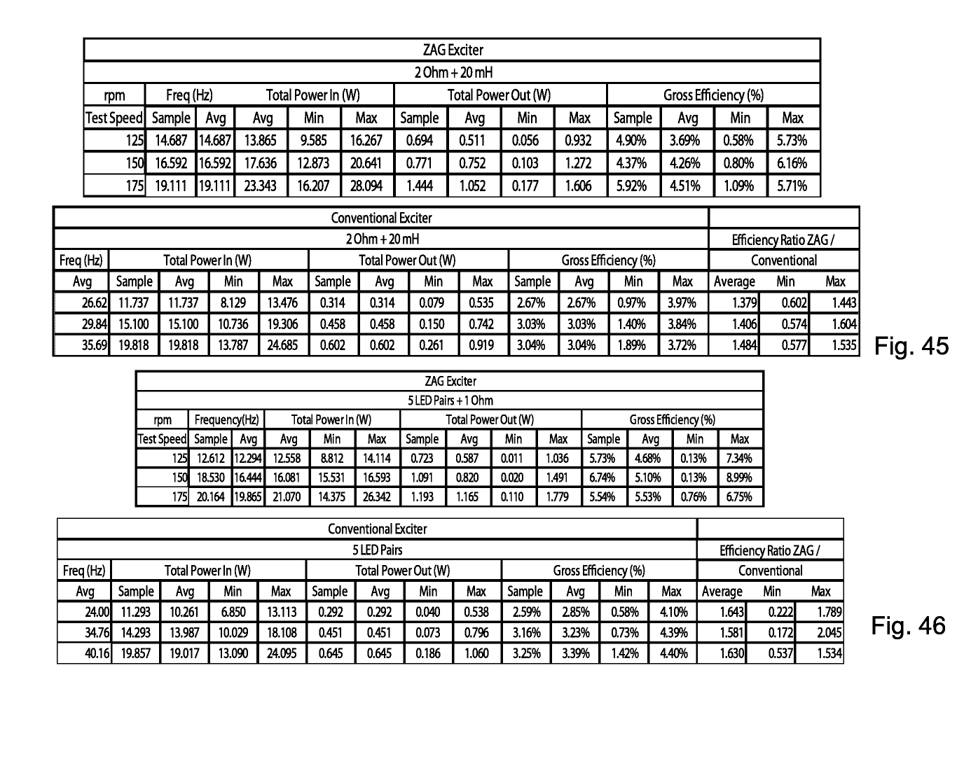

FIG. 42 show the results of a 2 Ohm test with a real load of 2.21 Ohms; FIG. 43 shows the results of an 11 Ohm test with a real load of 11.48 Ohms; FIG. 44 shows the results of an 16 Ohm test with a real load of 16.27 Ohms; FIG. 45 shows the results of an RL test—2 Ohm+20 mH in Series; FIG. 46 shows the results of an LED test—5 LED Parallel Pairs+1.015 Ohm Resistor in Series.

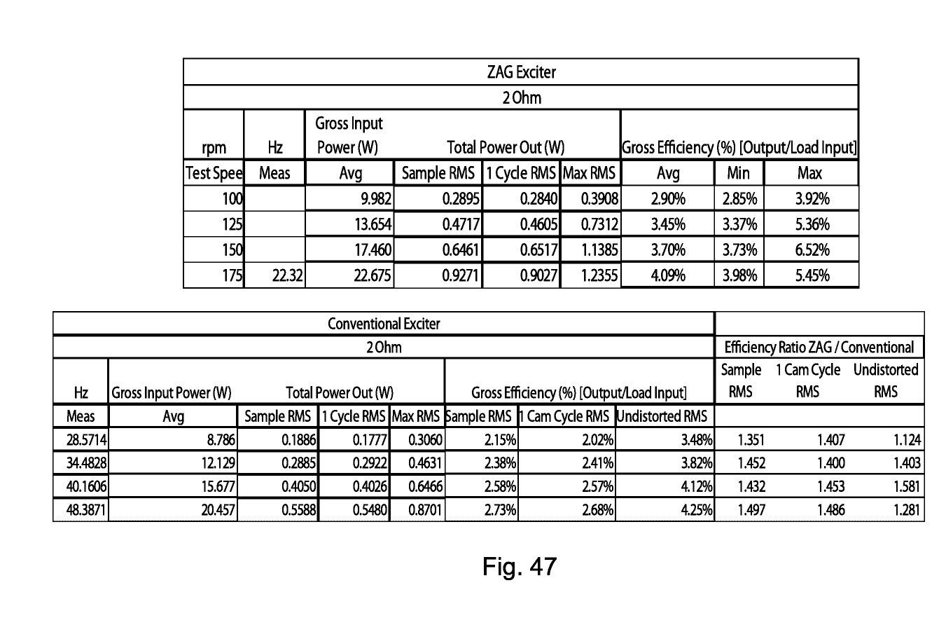

FIGS. 47 to 50 are tables showing the gross efficiency test results (Oscilloscope Output Data) for the exciter of the present invention and the Halbach exciter.

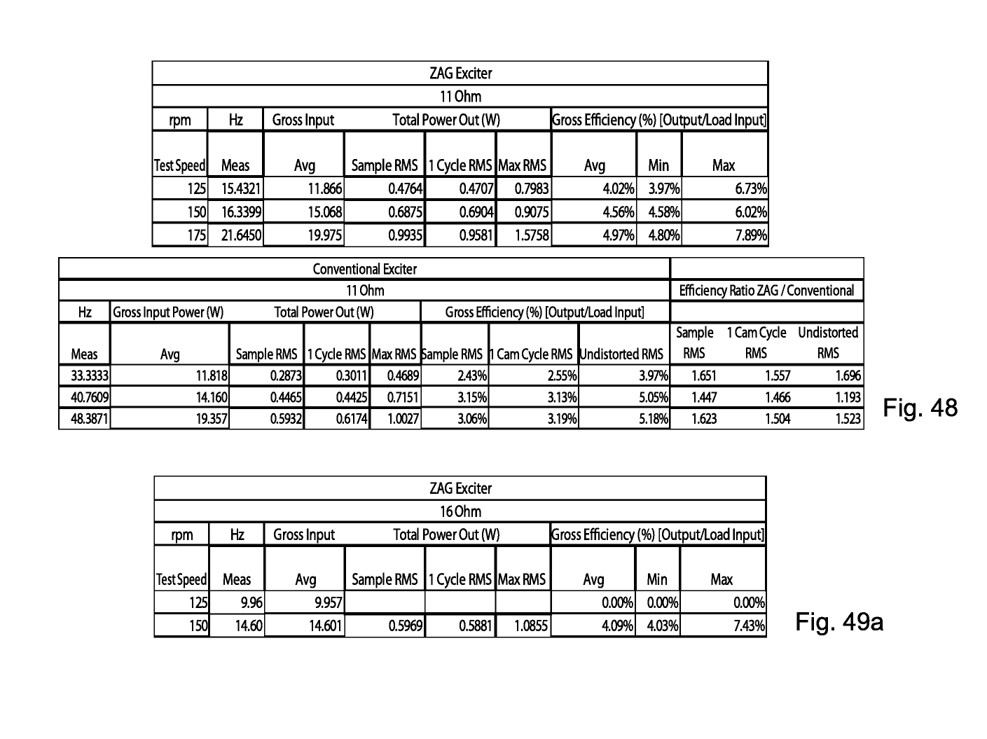

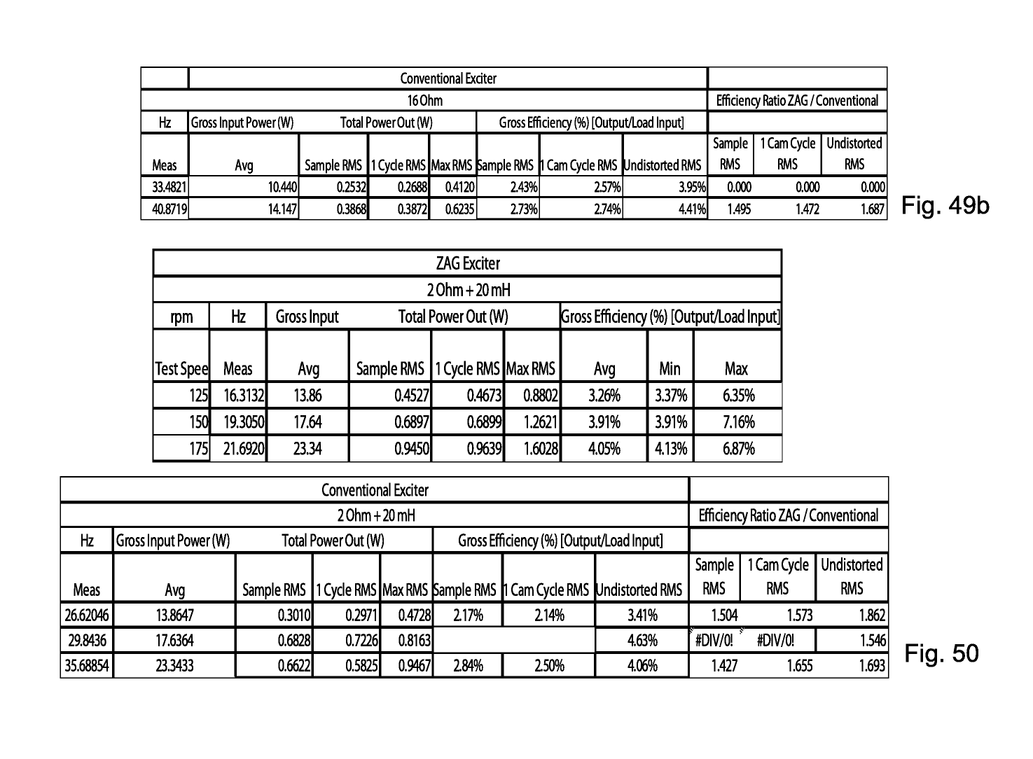

FIG. 47 shows the results of a 2 Ohm test with a real load of 2.21 Ohms; FIG. 48 shows the results of an 11 Ohm test with a real load of 11.48 Ohms; FIGS. 49a and 49b show the results of an 16 Ohm test with a real load of 16.27 Ohms; FIG. 50 shows the results of an RL test—2 Ohm+20 mH Inductor.

Overall the results show the exciter of the present invention to be between 15%-60% more efficient in terms of gross power in to power out than the conventional Halbach design used as a control. This was verified using data collected from both a Power Analyser and oscilloscope.

It is suspected that the performance difference is primarily achieved by the fact that the exciter of the present invention produces a much larger rate of change of magnetic flux to the coil when compared with the Halbach generator. According to Faraday's Law: the increased rate of change produces a larger voltage amplitude.

The ‘peaking’ waveform however does not fully carry over to the average voltage output. A higher crest factor of 1.7 for the undistorted exciter waveform of the present invention shows that the ratio of the peak output/average is 20% higher than for either the Halbach or an ideal sine wave generator.

The instantaneous power output from the generator of the present invention is 2 to 2.5 times that produced by the Halbach design. The effect of the higher crest factor is to reduce the useful output (RMS) to a magnitude of 1.4 to 1.6 greater.

There are harmonics present in the voltage output waveform (and naturally the current waveform) for both exciters as they are both non-ideal prototypes.

The undistorted waveform of the present invention has higher harmonic content in terms of the number and magnitude of harmonics present. The most prominent harmonic is the 3rd order with magnitude of 9.3%. There was also a number of inter-harmonics present in the waveform, which may be the result of non-constant velocity of the coil, driven along the track or aliasing of the digital oscilloscope measurement.

All results stated above must also be qualified on the basis the power analyser data was subject to the fact that output waveform of the generators was distorted at both ends of the cycle due to the limitations of the test rig.

Aspects of the present invention have been described by way of example only and it should be appreciate that additions and/or modifications may be made thereto without departing from the scope thereof as defined in the appended claims.

1-33. (canceled)

34. An electromagnetic generator for generating electricity comprising:
an exciter comprising at least one magnet, the exciter having a first magnetic flux,
an electrical conductor operable to generate a second magnetic flux when moved relative to the first magnetic flux,
means for causing relative motion between the first magnetic flux and the conductor such that the second magnetic flux generated at the conductor opposes the motion of the first magnetic flux relative to the conductor to simultaneously generate an electromotive force (EMF) and a potential energy that is stored in the second magnetic flux,
means for controlling the relative motion between the first magnetic flux and the conductor so that the potential energy stored in the conductor is released by allowing the second magnetic flux to collapse unimpeded by the first magnetic flux, and
means for converting the released potential energy to an electromotive force (EMF) across the conductor.

35. An electromagnetic generator as claimed in claim 34, further comprising means for moving the exciter and/or the conductor to cause the relative motion between the first magnetic flux and the conductor.

36. An electromagnetic generator as claimed in claim 34, further comprising means for moving the first magnetic flux relative to the conductor to cause the relative motion between the first magnetic flux and the conductor.

37. An electromagnetic generator as claimed in claim 34, in which the means for moving the exciter and/or the conductor comprises mechanical moving means operable to move the exciter relative to the conductor.

38. An electromagnetic generator as claimed in claim 34, in which the exciter comprises an arrangement of a translator, magnets and ferrous material together providing a magnetic circuitry, whereby the relative motion between the first magnetic flux and the conductor is caused by relative movement of parts of the magnetic circuitry.

39. An electromagnetic generator as claimed in claim 38, in which a potential energy is stored in the translator of the magnetic circuitry of the exciter and is released independently of a supply energy used to power the means for causing relative motion between the first magnetic flux and the conductor.

40. An electromagnetic generator as claimed in claim 39, in which the potential energy stored in the magnetic circuitry of the exciter is released non-instantaneously relative to the supply energy.

41. An electromagnetic generator as claimed in claim 38, in which the conductor extends around a perimeter of the exciter, and a surface of the exciter is in contact with a surface of the conductor.

42. An electromagnetic generator as claimed in claim 41, in which there is no air gap between the contacting surface or contacting surfaces of the conductor and the exciter.

43. An electromagnetic generator as claimed in claim 34, in which the exciter and the conductor are immersed in a protective fluid.

44. An electromagnetic generator as claimed in claim 43, in which the protective fluid is epoxy resin.

45. An electromagnetic generator as claimed in claim 34, in which the magnet of the exciter is an electromagnet.

46. An electromagnetic generator as claimed in claim 34, in which the magnet of the exciter is a permanent magnet.

47. A transformer comprising at least one primary conductor and at least one secondary conductor, the primary conductor having a first supply energy source and the secondary conductor for producing an EMF output,
the primary conductor comprising at least one electromagnet, the primary conductor having a first magnetic flux,
the secondary conductor operable to generate a second magnetic flux when moved relative to the first magnetic flux,
means for causing relative motion between the first magnetic flux and the secondary conductor such that the second magnetic flux produced at the secondary conductor opposes the motion of the first magnetic flux relative to the secondary conductor to simultaneously produce an electromotive force (EMF) across the or each secondary conductor and generate a potential energy that is stored in the second magnetic flux,
means for controlling the relative motion between the first magnetic flux and the secondary conductor so that the potential energy stored in the conductor is released by allowing the second magnetic flux to collapse unimpeded by the first magnetic flux, and
means for converting the released potential energy to an electromotive force (EMF) across the secondary conductor.

48. The transformer as claimed in claim 47, in which the first supply energy source is an electrical energy supply having an alternating current (AC).

49. The transformer as claimed in claim 48 connected to a generator comprising:
an exciter comprising at least one magnet, the exciter having a first magnetic flux,
an electrical conductor operable to generate a second magnetic flux when moved relative to the first magnetic flux,
means for causing relative motion between the first magnetic flux and the conductor such that the second magnetic flux generated at the conductor opposes the motion of the first magnetic flux relative to the conductor to simultaneously generate an electromotive force (EMF) and a potential energy that is stored in the second magnetic flux,
means for controlling the relative motion between the first magnetic flux and the conductor so that the potential energy stored in the conductor is released by allowing the second magnetic flux to collapse unimpeded by the first magnetic flux, and
means for converting the released potential energy to an electromotive force (EMF) across the conductor,
in which the electrical energy supply is provided by the electromotive force (EMF) across the conductor of the generator.

50. An electric motor for generating mechanical energy, the motor connected to an electrical energy supply source and comprising:
an armature,
a stator,
one of the armature and the stator comprising at least one magnet, and
the other of the armature and the stator forming an electrical conductor operable to produce a magnetic flux when connected to the electrical energy supply,
the electrical energy supply causing relative motion between the armature and the stator and to simultaneous produce a potential energy that is stored in the magnetic flux of the conductor,
means for controlling the electrical energy supply so that the potential energy stored in the magnetic flux of the conductor is released by allowing the magnetic flux to collapse unimpeded by the electrical energy supply, and
means for converting the released potential energy to mechanical energy causing further relative motion between the armature and the stator independently of the electrical energy supply.

51. A method of generating electricity comprising the steps of:
providing an exciter comprising at least one magnet, the exciter having a first magnetic flux,
providing an electrical conductor operable to generate a second magnetic flux when moved relative to the first magnetic flux,
operating means for causing relative motion between the first magnetic flux and the conductor such that the second magnetic flux generated at the conductor opposes the motion of the first magnetic flux relative to the conductor to simultaneously generate an electromotive force (EMF) and store a potential energy in the second magnetic flux,
controlling the relative motion between the first magnetic flux and the conductor so that the potential energy stored in the conductor is released by allowing the second magnetic flux to collapse unimpeded by the first magnetic flux, and
converting the released potential energy to an electromotive force (EMF) across the conductor.

52. A method of generating electricity as claimed in claim 51, comprising a step of: moving the exciter and/or the conductor to cause the relative motion between the first magnetic flux and the conductor.

53. A method of generating electricity as claimed in claim 51, comprising a step of: providing an arrangement of a translator, magnets and ferrous materials together having a magnetic circuitry, and moving parts of the magnetic circuitry to cause the relative motion between the first magnetic flux and the conductor.

54. A method of generating electricity as claimed in claim 53, comprising a step of: providing a supply energy to power the means for causing relative motion between the first magnetic flux and the conductor and potential energy stored in the translator of the magnetic circuitry of the exciter is released independently of the supply energy.

55. A method of generating electricity as claimed in claim 54, comprising a step of: releasing the potential energy stored in the magnetic circuitry of the exciter non-instantaneously relative to the supply energy.

56. A method of generating electricity as claimed in claim 51, comprising a step of: immersing the exciter and the conductor in a protective fluid.

57. A method of producing an electromotive force (EMF) output comprising the steps of:
providing a transformer comprising: a primary conductor having at least one electromagnet, the primary conductor having a first magnetic flux, and a secondary conductor operable to generate a second magnetic flux when moved relative to the first magnetic flux;
providing a first supply energy source to the primary conductor;
operating means for causing relative motion between the first magnetic flux and the secondary conductor such that the second magnetic flux produced at the secondary conductor opposes the motion of the first magnetic flux relative to the secondary conductor to simultaneously produce an electromotive force (EMF) across the or each secondary conductor and generate a potential energy that is stored in the second magnetic flux,
controlling the relative motion between the first magnetic flux and the secondary conductor so that the potential energy stored in the conductor is released by allowing the second magnetic flux to collapse unimpeded by the first magnetic flux, and
converting the released potential energy to an electromotive force (EMF) across the secondary conductor.

58. A method of producing an electromotive force (EMF) output as claimed in claim 57, comprising the step of: providing the first supply energy source as an electrical energy supply having an alternating current (AC).

59. A method of producing an electromotive force (EMF) output as claimed in claim 58 comprising a step of: connecting the transformer to a generator comprising:
an exciter comprising at least one magnet, the exciter having a first magnetic flux,
an electrical conductor operable to generate a second magnetic flux when moved relative to the first magnetic flux,
means for causing relative motion between the first magnetic flux and the conductor such that the second magnetic flux generated at the conductor opposes the motion of the first magnetic flux relative to the conductor to simultaneously generate an electromotive force (EMF) and a potential energy that is stored in the second magnetic flux,
means for controlling the relative motion between the first magnetic flux and the conductor so that the potential energy stored in the conductor is released by allowing the second magnetic flux to collapse unimpeded by the first magnetic flux, and
means for converting the released potential energy to an electromotive force (EMF) across the conductor,
such that the electrical energy supply is provided by the electromotive force (EMF) across the conductor of the generator.

60. A method of generating mechanical energy comprising the steps of:
providing an electric motor comprising: an armature and a stator,
connected the electric motor with an electrical energy supply source
providing one of the armature and the stator with at least one magnet,
configuring the other of the armature and the stator as an electrical conductor operable to produce a magnetic flux when connected to the electrical energy supply,
controlling the electrical energy supply to cause relative motion between the armature and the stator and to simultaneous produce a potential energy that is stored in the magnetic flux,
further controlling the electrical energy supply so that the potential energy stored in the magnetic flux is released by allowing the magnetic flux to collapse unimpeded by the electrical energy supply, and
converting the released potential energy to mechanical energy causing further relative motion between the armature and the stator independently of the electrical energy supply.
